(19) United States
(12) Patent Application Publication
(10) Pub. No.: US 2010/0125449 A1
(43) Pub. Date: May 20, 2010

(54) Integratd phonetic Chinese system and inputting method thereof

(76) Inventor: Cheng-Tung Hsu, Taipei (TW)

Correspondence Address: DAVID AND RAYMOND PATENT FIRM, 108 N. YNEZ AVE., SUITE 128, MONTEREY PARK, CA, 91754, US

(21) Appl. No.: 12/313,198

(22) Filed: Nov. 17, 2008

(51) Int. Cl. G06F 17/20

(52) U.S. Cl. 704/8; 704/E15.003

(57) ABSTRACT

An Integrated Phonetic Chinese System includes a module of Chinese pronunciation keys, a module of Romanized Chinese scripts, a module of input method that allows users to input Chinese characters and pronunciation keys and Romanized scripts and a module of advanced input method utilizing a 24 key position matrix that allows users to input Chinese characters and pronunciation keys and Romanized script with maximum speed and efficiency.

### BACKGROUND OF THE PRESENT INVENTION

1. Field of Invention

The present invention relates generally to the phonetization and Romanization of Chinese language and Chinese input methods.

2. Description of Related Arts

Chinese is not an alphabetical language. Its characters are ideograms. There isn't any pronunciation information contained in the written Chinese characters. Numerous methods have been invented to serve as pronunciation guide to Chinese speakers and learners. They include Wade-Giles, Yale, Tongyong, Pinyin, Bopomofo etc.

Among them, only Bopomofo is not based on Roman alphabets. It uses some component glyphs of Chinese characters as the pronunciation keys. There are altogether 37 symbols ( [symbol] [symbol] [symbol] [symbol] [symbol] [symbol] ) and 5 tonal marks (Tone 1 is represented by omission. Tone 2, 3, 4 and light sound are [symbol] respectively).

In this Bopomofo system, sound element symbols are written first and tonal marks are written last. Example: [symbol] is a typical Bopomofo representation of a Chinese sound. The two symbols [symbol] represent the sound elements of the Chinese word and the last symbol [symbol] designates the tone 4.

This wonderful system has been in use since 1918. Taiwan residents still use this system to teach their children the correct pronunciation of Chinese words. A vast number of children books are printed with those Bopomofo symbols alongside the Chinese characters. Taiwanese love this Bopomofo system very dearly as it is most precise in the representation of Chinese sounds by a set of symbols.

Among those other Chinese pronunciation guide systems that do use Roman alphabets, Pinyin is now the most widely used. It is because China government adopted this system in 1979. With such a big user base, it gradually gained an upper hand in the realm of Chinese language teaching. Nowadays majority of foreign learners of Chinese language use Pinyin as pronunciation guide.

Pinyin literally means ‘spell’ and ‘sound’ in Chinese. The word ‘spell’ implies that it is a spelling and transcribing tool transcribing Chinese words into Roman scripts. The word ‘sound’ implies that it is also used as Chinese pronunciation guide.

Unfortunately, Pinyin behaves more like a scripting tool and much less like a competent pronunciation guide. Note that good pronunciation guide systems, by definition, are created to guide people to pronounce words by looking at the symbols. In order for that function to be effective, each symbol has to have just one possible sound associated with it.

However, English language scripts do not follow this one-symbol-one-sound principle. For example, in English there are at least four different pronunciations for ‘ea’ (as in bead, heard, great and threat). Words, written in English, typically do not fully define their proper pronunciations. Learners need to consult dictionaries to get at the pronunciation information of the words.

Pinyin acts similar to English language scripts in this regard. Pinyin users need to memorize many complex rules to be able to make sense of the correct pronunciation of the corresponding Chinese word. They cannot look at the Pinyin script and pronounce the word directly. It is quite unlike the pronunciation key system used by Meridian Webster or other dictionaries. People just have to look at the pronunciation key symbols of a word and pronounce the word directly.

We use an example to demonstrate above observation regarding Pinyin. Note that in Pinyin, the u in ‘du’ and ‘ju’ is pronounced differently. The u in du, in Pinyin script, is of the [symbol] sound of Bopomofo, while the u in ju is of the [symbol] sound of Bopomofo.

Users of Pinyin system, therefore, have to memorize all those pronunciation individually, much like English users who have to memorize all the different pronunciation of ea in bead, heard, great and threat.

Pinyin, therefore, is not an effective pronunciation guide for people speaking or learning Chinese. It does not follow the one-symbol-one-sound principle. Its symbols are not uniquely and independently defined pronunciation keys. This is the first weakness of Pinyin.

The second weakness of Pinyin is that it is incompatible with English phonics. Following excerpt from Wikipedia says it all. It says, “Debate continues about the actual suitability of Pinyin as a Chinese Romanization method. This argument revolves around Pinyin's unconventional use of Roman letters, of which the phonological value of some phonemes is quite different from that of most languages utilizing Roman alphabets.”

An example to demonstrate this assertion is that the ai used in Pinyin has a pronunciation of i as in like. While according to English phonics, ai would almost always be pronounced like ai as in maid, or waist, or tail.

In the official alphabet table released by Chinese government as a part of the Pinyin project, the 26 Roman alphabets have official pronunciations that are completely different from the English ways. For example, instead of pronouncing the first 4 alphabets ay (as in ray), bee (as in bee), see (as in seed), dee (as in deep), the Pinyin pronounced them as [symbol] (roughly like aa, buh, tsuh, duh) which are very different from the English way of pronouncing those alphabets.

So it is plain to see that Pinyin was never designed to be compatible with English phonics. It looks familiar to English speaking people. However, this look of familiarity is deceptive. It is actually very difficult for English-speaking people to use this Pinyin system to get at the correct pronunciation of Chinese words.

The third weakness of Pinyin lies in the way it conveys the all-important tonal information of Chinese words. It uses many symbols that come with diacritics, such as ā [symbol] [symbol] [symbol] to designate the tonal marks. Nobody, other than the printing press, can easily produce such a vast number of exotic symbols. The net result is that majority of all scripts written in Pinyin are using a functionally reduced version which is stripped of the diacritics. Example: properly constructed Pinyin script for the capital of China is [symbol] while the functionally reduced Pinyin script is Beijing.

In real life usage of Pinyin, people will find that the functionally reduced Pinyin is most predominant. It is printed on each box of each consumer product in China. It is used in road signs and business signs. Actually, majority of dictionaries would even print ‘Zi Dian’ (functionally reduced Pinyin script of ‘dictionary’) instead of zi [symbol] (the fully constructed Pinyin script of ‘dictionary’) on their covers. The fully constructed Pinyin scripts exist almost only inside dictionaries and language courses.

The fact that Pinyin does not offer a good solution for people to generate those diacritics symbols is doubtlessly the main reason behind such an absurd phenomenon (that a tonal language, like Chinese, is stripped of this essential tonal information when transcribed). This is perhaps the greatest weakness of Pinyin as a pronunciation guide to the Chinese words.

We conclude that there is a pressing need for a better Chinese pronunciation key system that does conform to one-symbol-one sound principle. There is also the need of a better Romanized scripting system that is compatible with English phonics. The new pronunciation key system and new Romanized scripting system should both have a solution to allow users to generate the tonal marks easily.

Speaking of Chinese pronunciation key system, Bopomofo does the job extremely well. The 37 symbols plus 5 tones interprets the Chinese sounds perfectly. It is essentially one-symbol-one-sound (except in the case of [symbol] sounds which can form a different sound when it's preceded by [symbol] ). Aside from this minor discrepancy, Bopomofo is as close as can be a perfect one-symbol-one-sound pronunciation key system for Chinese language.

The only drawback of Bopomofo system, regarding its usability for English speaking people, is that it is incompatible with English. It is not user-friendly. Therefore, Bopomofo does not fill the need of a true pronunciation key system for English speaking people.

Prior art #1, the predecessor of the system module #1 of this present invention uses 26 Roman alphabets (A to Z) to represent 30 different Chinese sound elements, and 7 number keys (1, 2, 3, 4, 5, 7, 9) to represent another 7 Chinese sound elements. It is the first attempt in the world to use alphanumerical symbols to represent Chinese sound elements.

It derived 7 laws governing the pronunciation of Chinese words and proved beyond any doubt that it can reuse some of the consonant alphabets to represent vowels without causing confusion. This is the main technical breakthrough of the prior art #1.

Furthermore, it uses 4 numbers (1,2,3,4), to represent the 4 tonal levels of Chinese sounds. It does not have a representation for the light sound due to the inability to incorporate it into one of its components - the 8x8 matrix. This is a serious defect for prior art #1.

Prior art #1 uses special fonts to create those 37 sound element symbols. Four alphabets (G, L, H, N) are shown in two different fonts to manifest different visual symbols that represent the Chinese sound elements. Prior art #1 uses a third font to show its tonal mark symbols. Altogether 3 fonts are used in this prior art #1 phonetic system.

Using this font technique prior art #1 was able to use the familiar alphabets and numerals to generate enough Chinese sound element symbols.

Note those individual alphabets (A to Z) and numbers (1, 2, 3, 4, 5, 7, 9) thus used are called namesake keys, while the formal symbols are represented in special fonts.

If we closely examine all those namesake keys used in prior art #1, we would find out that 4 of the alphabets are used in both consonants and vowels. They are the alphabets H, L, G, N. How can this scheme work? Would there be confusion in the meaning of those keys?

Actually, there is no confusion. Prior art #1 derived this conclusion by tapping into some special laws governing the pronunciation of Chinese words. Those laws were rarely known to Chinese people and were never utilized to design a pronunciation key system. Yet they are true. Each Chinese word is bound by these 7 laws, while none of them apply to English or other major languages. Those 7 laws are, therefore, uniquely Chinese. Prior art #1 was the first to document those laws and use those laws to design a Chinese pronunciation key system.

Those 7 laws governing Chinese pronunciation can best be described by properly grouping all those 37 Chinese sound elements and tonal marks (as was long established by Bopomofo since 1918) into 4 major groups—group A,B,C and D. One of the groups, namely group A, needs to be further sub-grouped into two sub-groups A1 and A2) because in some situation the two sub groups behave differently.

Group A:

Group A consists of elements [symbol] [symbol] [symbol] [symbol] (in Bopomofo symbols), or [symbol] [symbol] [symbol] (in symbols designed by prior art #1). Within this group, 2 sub-groups are defined as below:

Sub-group A1:

[symbol]

[symbol]

[symbol]

[symbol]

[symbol]

Sub-group A2:

[symbol] (or

[symbol]

Group B:

[symbol] (or

[symbol]

Group C:

[symbol] [symbol] (or [symbol] [symbol] )

Group D:

The four tones, represented as [symbol] (or [symbol] as in prior art #1)

Note prior art #1 cannot handle light sound. But this omission does not affect the discussion of the 7 laws governing the Chinese pronunciation.

After all sound elements and the tonal elements of Chinese are thus grouped, following seven laws are found to be always true. They apply to the official way of pronouncing Chinese words commonly referred to as Mandarin Chinese (or Putonghua) without any exception.

Law #1: The pronunciation key script of each of all Chinese words must conform to the following scheme: It would include one element of at least one of the 3 sound element groups, namely (group A, B, and C). It would definitely have a tonal element group D to represent its tone. Each Chinese sound is constructed this way. There is no exception.

Law #2: Only one element of any group of sound could possibly be in a Chinese sound pronunciation key script. Therefore, if an element is present in a Chinese sound pronunciation key script, no other element in that particular group could be present.

Law #3: The sequence of the sound elements in any Chinese pronunciation key script would always follow the simple rules that: group A element precedes Group B element, Group B element precedes Group C element, Group C element precedes Group D element. Group D tone element would always be the last element of Chinese pronunciation key script.

Law #4:

This law is technically a corollary of the above 3 laws. We deduct from above 3 laws that the pronunciation of each and every Chinese word would be constructed in one of the 7 patterns listed below:

Pattern 1:
ABCD type, whereby A stands for an element of group A, B stands for an element of group B, C stands for an element of Group C and D stands for an element of tone group D. Example: [symbol] (or

[symbol]

Pattern 2:

BCD type. Example: [symbol] (or

[symbol]

Pattern 3:

ACD type Example: [symbol] (or

[symbol]

Pattern 4:

ABD type Example: [symbol] (or

[symbol]

Pattern 5:

AD type Example: [symbol] (or

[symbol]

Pattern 6:

BD type Example: [symbol] (or

[symbol]

Pattern 7:

CD type Example: [symbol] (or

[symbol]

Law #5: When a Chinese word is of the AD type, that group A element must be of A2 subgroup. So type A2D sound is a valid Chinese sound while type A1D is not a valid Chinese word pronunciation. The true meaning of this rule is that A2 elements can act as vowels while A1 elements are pure consonants which cannot be pronounced alone.

Law #6: The sound element [symbol] (or 2̅ in prior art #1 symbol) always forms pattern 7 (type CD) Chinese sound. This element can never be in any of the other 6 patterns.

** remarks: this law is relevant to other modules of prior art #1. It is not relevant to our current invention. We included it because that is part of the original 7 laws of prior art #1.

Law #7: Element of A2 would never be followed by element [symbol] (or) of Group B. Such combination is not a valid Chinese word pronunciation.

** This is also relevant to other modules of prior art #1 and not relevant to our current invention. It is included because it is part of the original 7 laws of prior art #1.

Among those laws, law #5 has an important ramification. Since A1 element can never directly join D element to form a valid Chinese pronunciation, the namesake keys of A1 can be reused in Group C with no fear of confusion. The logical deduction of above assertion goes like this:

Premises 1: According to law #2, element of group C must precede element of group D. So there can never be anything between element of group C and element of group D.

Premises 2: According to law #5, A1 can never be followed by D. Such A1D combination is invalid.

Conclusion: If we use the same namesake key to represent a member of sub-group A1 and a member of group C, there would not be possibility of confusion. When this namesake key is away from D, then it is an A1 element. When this namesake key is directly before D, then it can only be group C element. No confusion is possible.

In other words, we now have an amazing conclusion that we can re-use the namesake keys of group A1 elements to represent group C element with no fear of confusion.

We name this newly derived law “the law of reusability of A1 subgroup namesake keys for group C namesake keys”. It is technically a corollary of the 7 laws of Chinese pronunciation.

Prior art #1, using above deducted conclusion, then are free to use 4 namesake alphabets (namely G, N, H, L) both in group A1 and group C. When used as group C element, the 4 alphabets take on special font to be shown as [symbol] (representing the sound elements [symbol] ). When they are used as group C element, those 4 elements would take on another font to be shown as [symbol] (representing the sound element [symbol] ).

With the help of the 7 laws as demonstrated above, prior art #1 successfully defined 37 sound symbols of Chinese words with 26 alphabets and 7 numbers. Four of the 26 alphabets (namely GHLN) were used both in group A and group C to make it possible.

Note the 38th sound elements [symbol] ) can only be represented by two symbols in both original Bopomofo system or in prior art #1 system.

There are altogether 38 distinctive Chinese sound elements. Prior art #1 uses 37 symbols to represent them. This is same as Bopomofo system. This is the weakness of both Bopomofo and prior art #1.

### SUMMARY OF THE PRESENT INVENTION

A main object of the present invention is to provide a system and method for representing the 38 Chinese sound elements and 5 tones with symbols that are familiar to the English speaking people. These sound symbols can then be used as the pronunciation keys of Chinese language.

Another object of the present invention is to provide a system and method for transcribing Chinese language into Romanized scripts that are highly compatible with English phonics.

Another object of the present invention is to provide a system and method for inputting Chinese pronunciation keys, Chinese Romanized scripts and Chinese characters. Since this input system is designed mainly for English speaking people, it should preferably be transparently integrated in the normal English editing environment. It is to be distinctively different from all existing Chinese input methods that require a Chinese-input-mode to be active before users can input any Chinese word.

Another object of the present invention is to provide a system and method for inputting Chinese pronunciation keys, Romanized Chinese scripts and Chinese characters with maximum speed and efficiency. This advanced input method is meant to serve the need of people who do Chinese input a lot and thus demand maximum speed and efficiency.

Accordingly, in order to accomplish the above objects, the present invention provides a system and method for Integrated Phonetic Chinese System, comprising four system modules as outlined below.

System module #1: A Chinese pronunciation key system that defines a set of phonetic symbols comprising of alphanumerical keys that represent the Chinese sounds and tones.

System module #2: A Chinese Romanization scripting system that defines the rules for transcribing Chinese words into Roman alphabetical scripts, with a scheme to show the tones of the Chinese words being transcribed.

System module #3: An input method that allows users to generate the pronunciation key scripts of module #1, the Roman alphabetical scripts of module #2, and regular Chinese characters using the alphanumerical keys defined in module #1.

We believe that for an English-speaking people, the ideal input method is one that is transparently integrated into the normal English editing mode. User never needs to use a certain key combination to shift into and out of the Chinese-input-mode. This important feature is not present in all the inputting methods available. This is one of the reasons why we want to design and integrate this new input method into our system. It aims at fulfilling those important needs of the English-speaking people.

System module #4: An input method that utilizes a 24 key position matrix derived from the Chinese pronunciation laws to achieve maximum input speed and efficiency.

These and other objectives, features, and advantages of the present invention will become apparent from the following detailed description, the accompanying tables and the appended claims.

### BRIEF DESCRIPTION OF THE TABLES

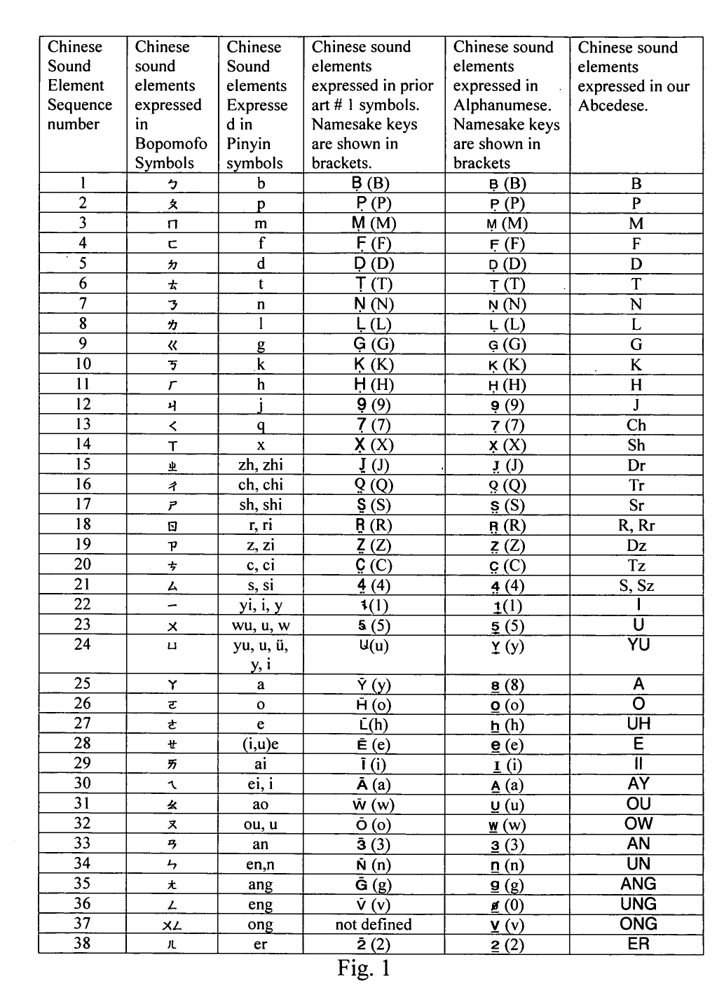

FIG. 1 is the comparison table of Chinese sound elements.

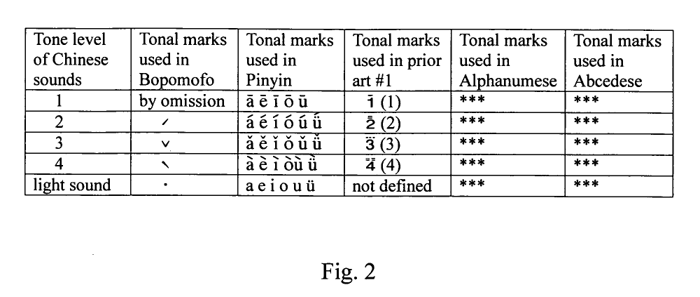

FIG. 2 is the table of two different ways that the prior arts and our system modules used to handle the tonal marks.

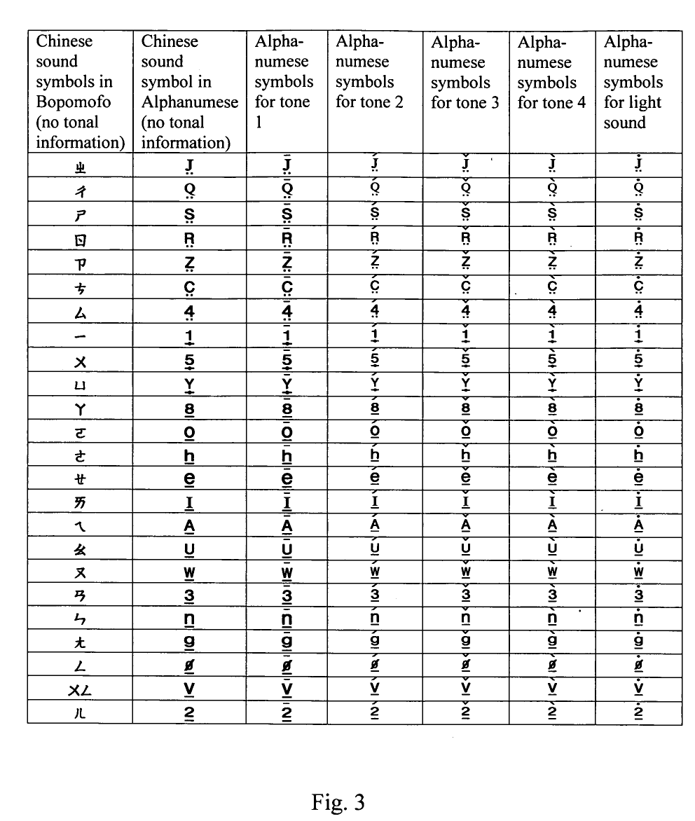

FIG. 3 is the table of the Alphanumese symbols with tonal information encoded.

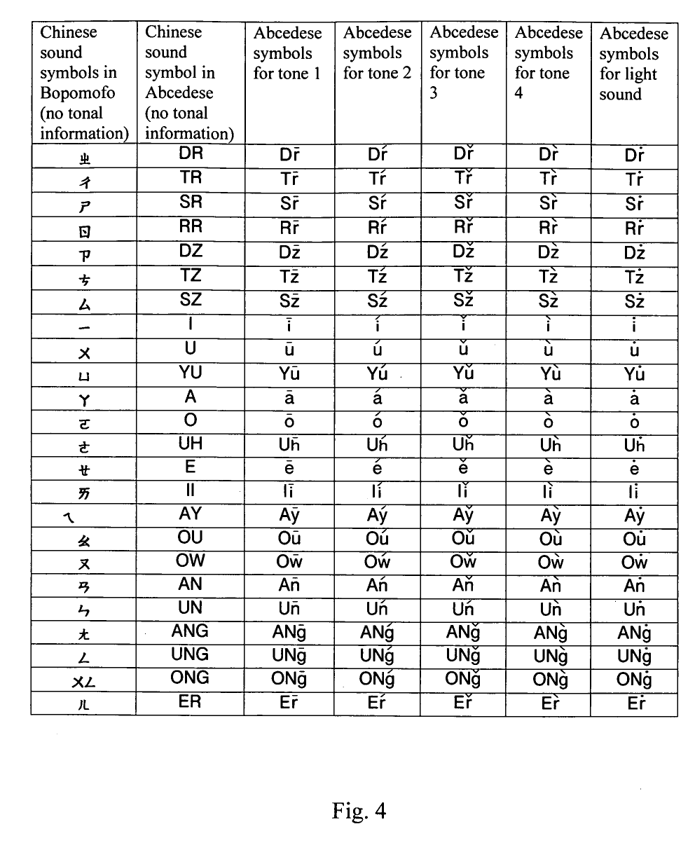

FIG. 4 is the table of the Abcedese symbols with tonal information encoded.

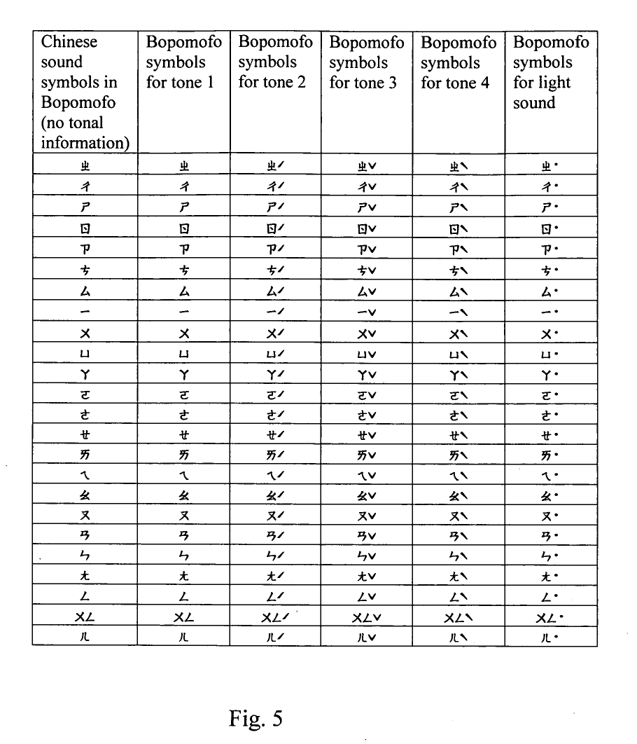

FIG. 5 is the table of the Bopomofo symbols with tonal information encoded.

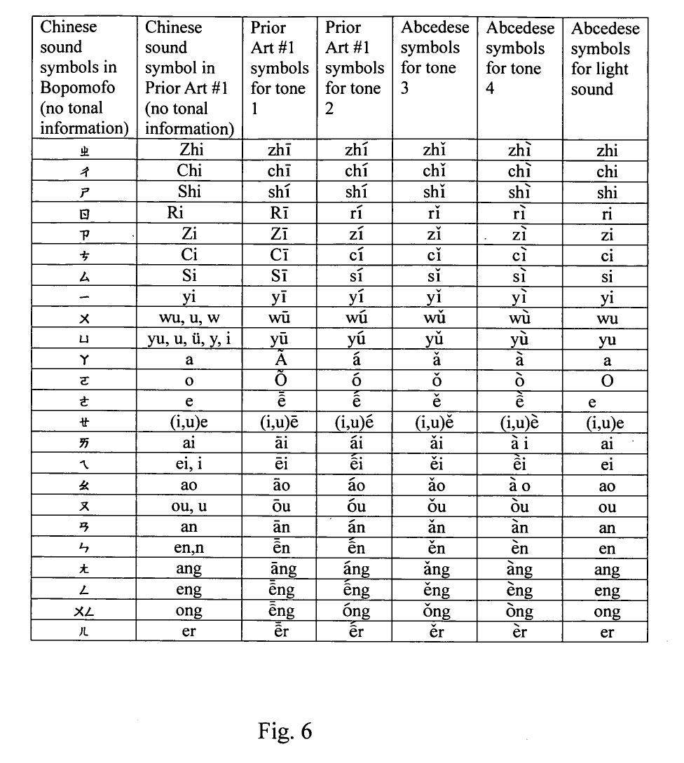

FIG. 6 is the table of the Pinyin symbols with tonal information encoded.

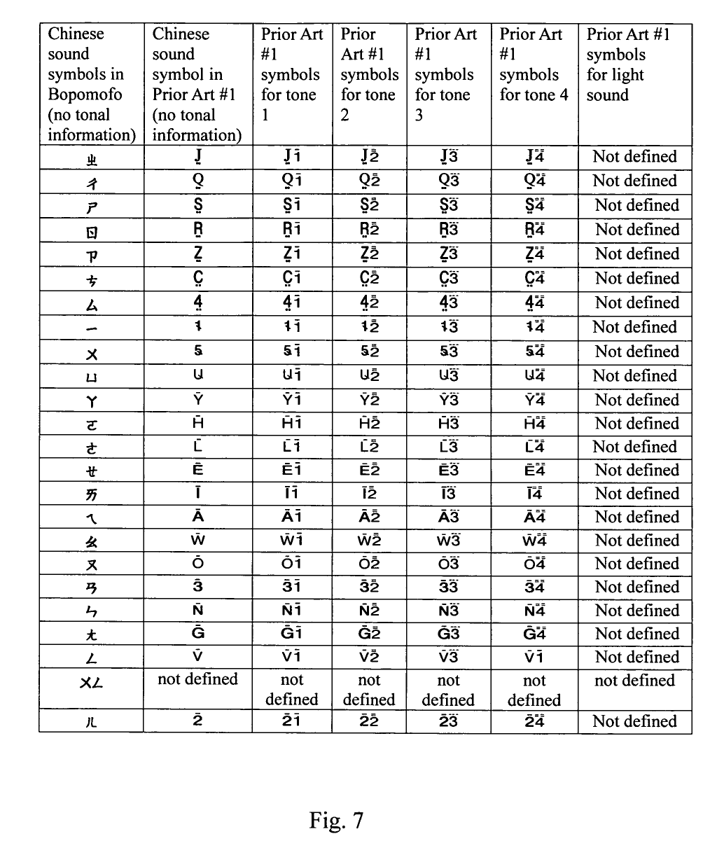

FIG. 7 is the table of the prior art #1 symbols with tonal information encoded

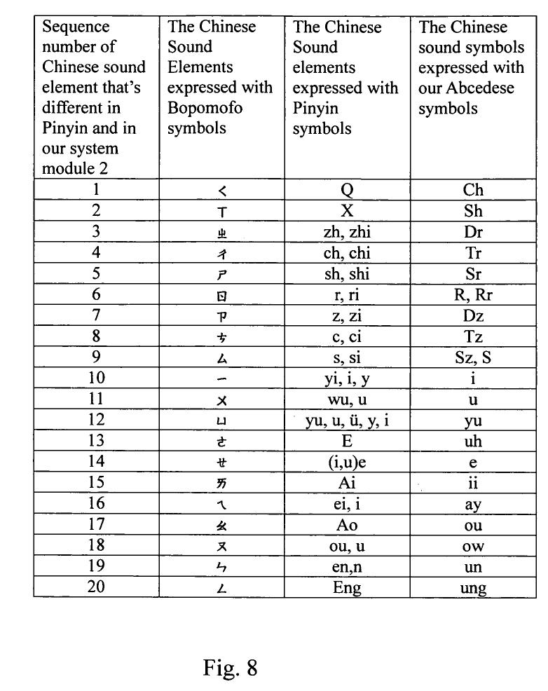

FIG. 8 is the table of the ostensible difference between the Pinyin symbols and our Abcedese symbols

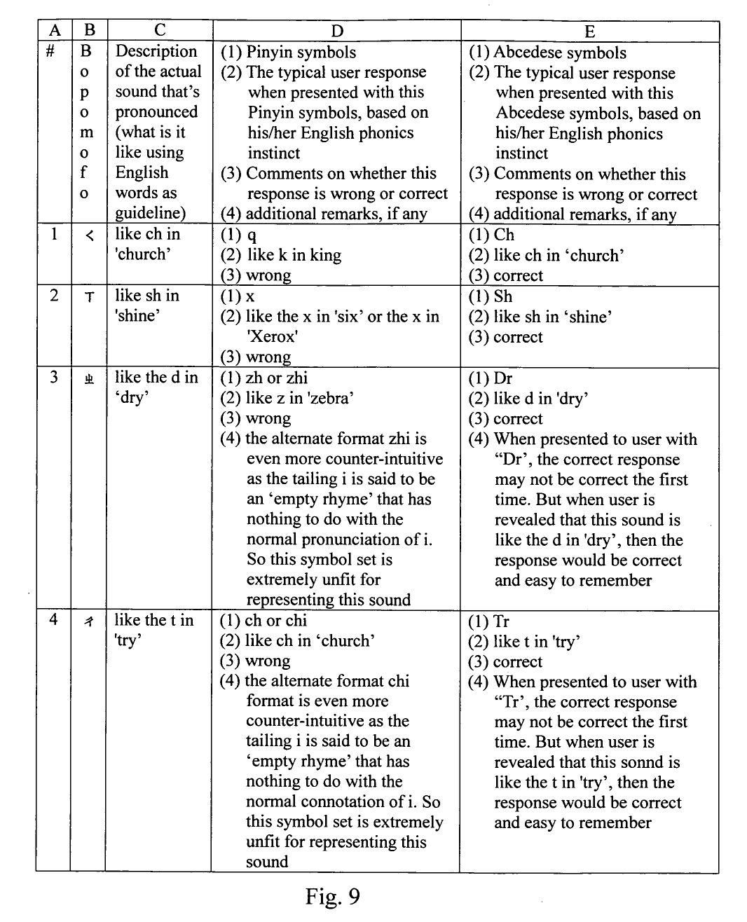

FIG. 9 is the table of sound-by-sound comparison between Abcedese and Pinyin from #1-#4.

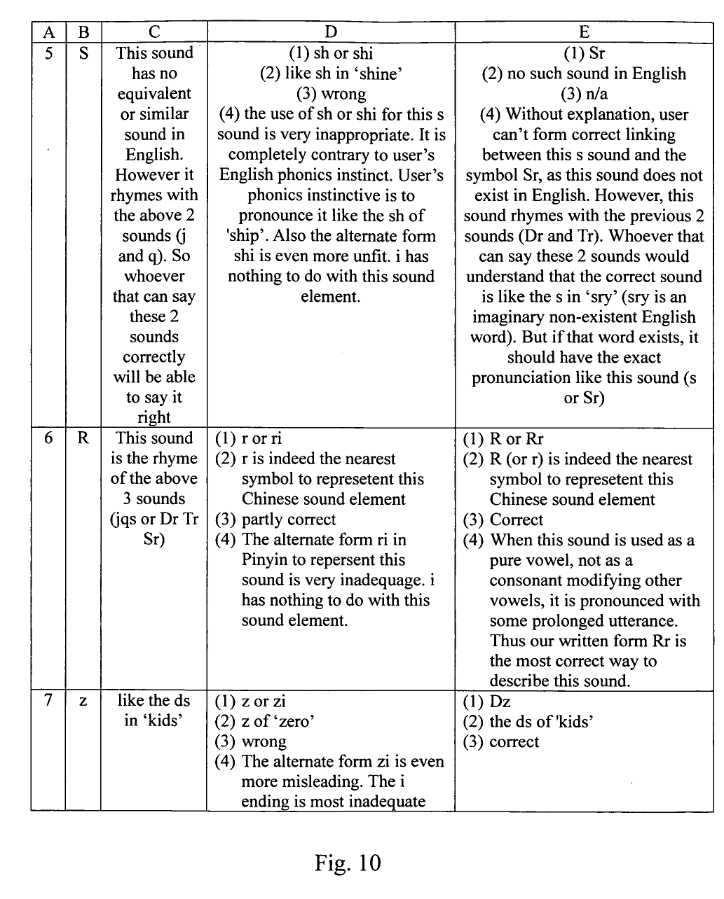

FIG. 10 is the table of sound-by-sound comparison between Abcedese and Pinyin from is #5-#7.

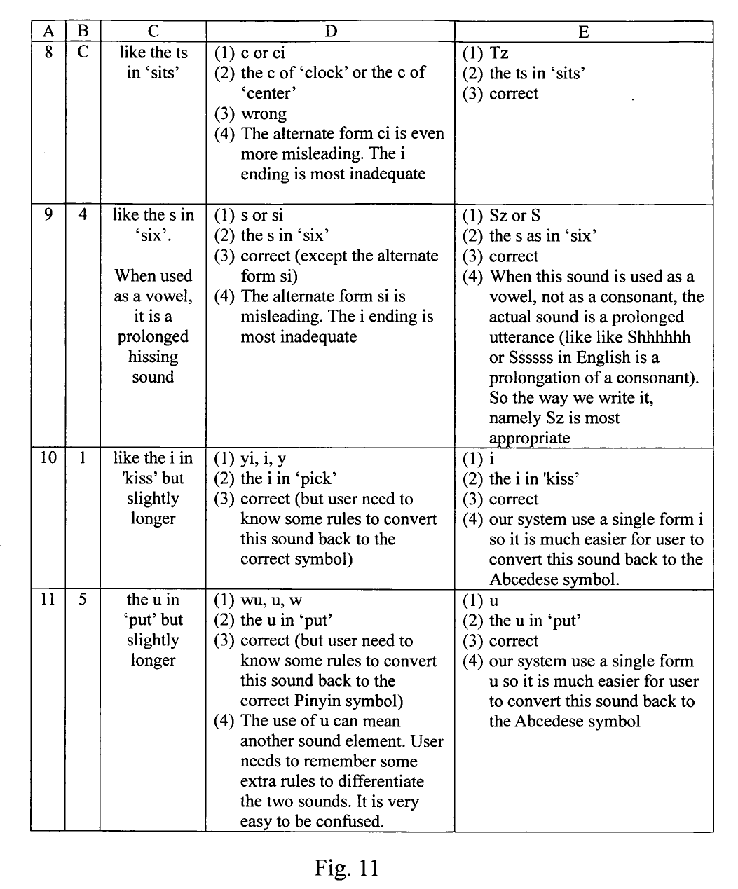

FIG. 11 is the table of sound-by-sound comparison between Abcedese and Pinyin from #8-#11.

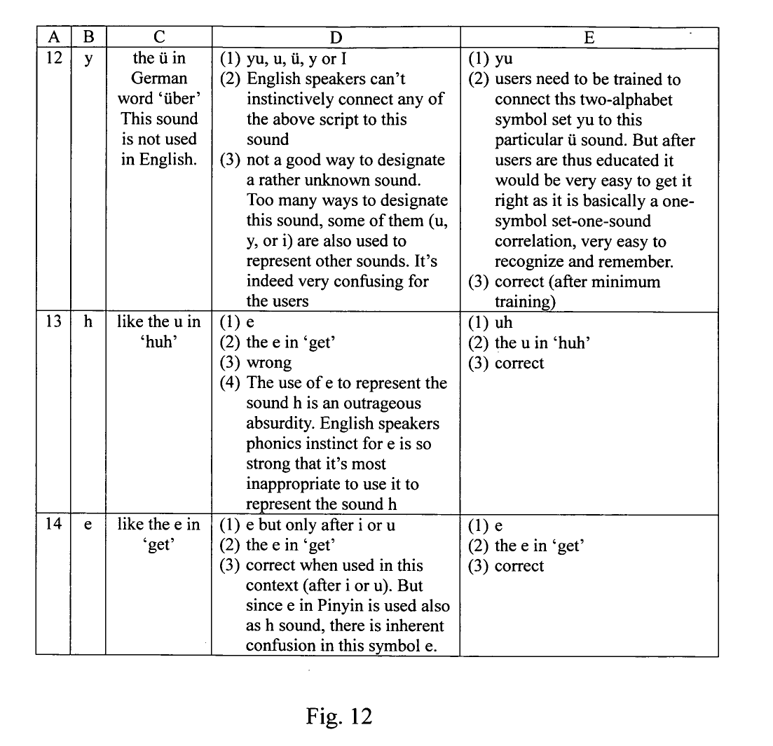

FIG. 12 is the table of sound-by-sound comparison between Abcedese and Pinyin from #12-#14.

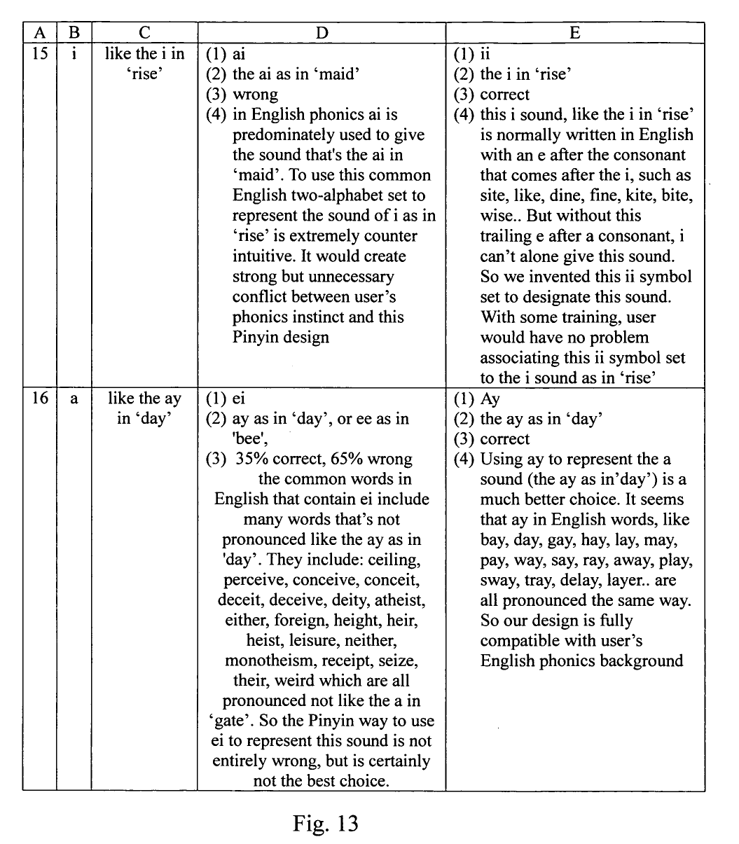

FIG. 13 is the table of sound-by-sound comparison between Abcedese and Pinyin from #15-#16.

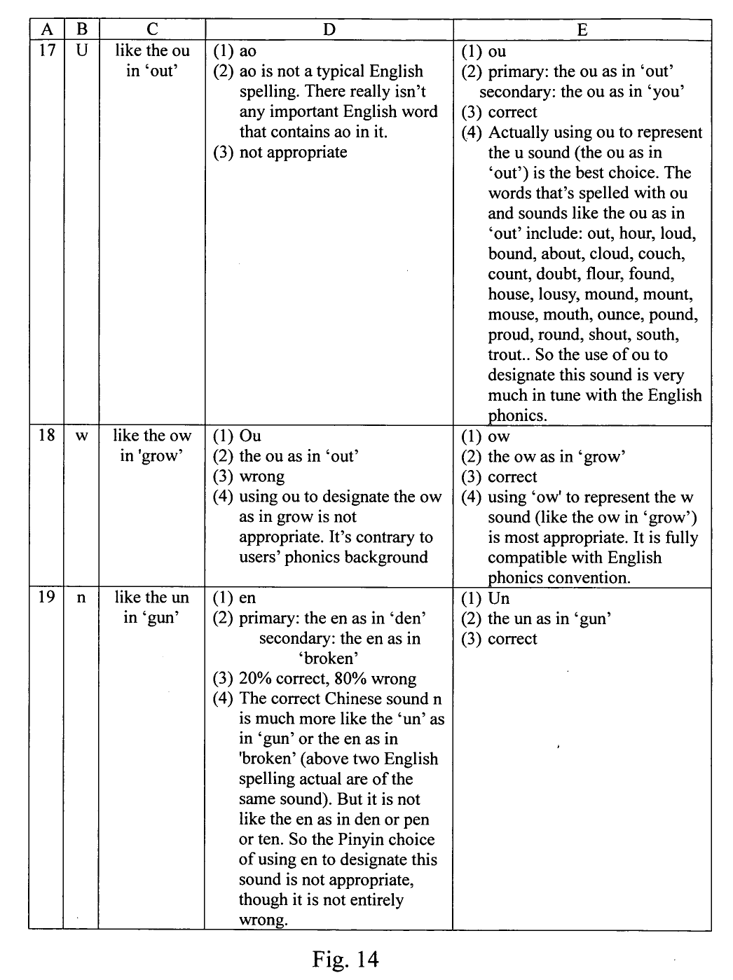

FIG. 14 is the table of sound-by-sound comparison between Abcedese and Pinyin from #17-#19.

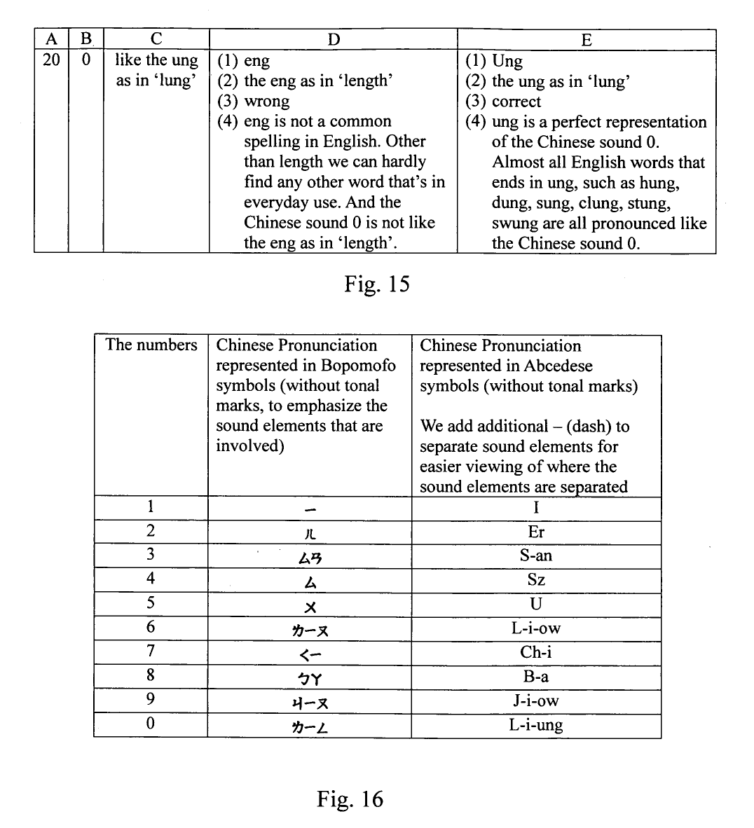

FIG. 15 is the table of sound-by-sound comparison between Abcedese and Pinyin #20.

FIG. 16 is the table of Pronunciation of Chinese numbers, from 0 to 9.

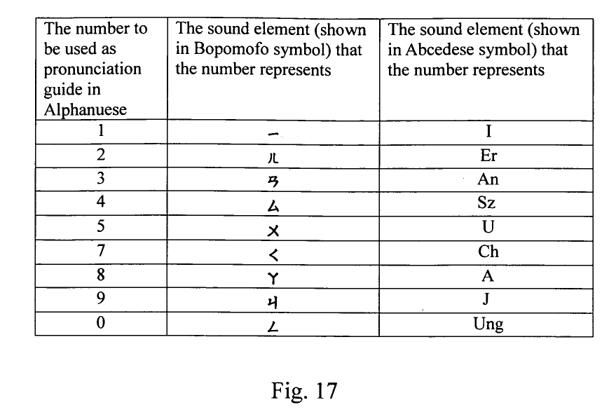

FIG. 17 is the table of Chinese numbers as sound element symbols.

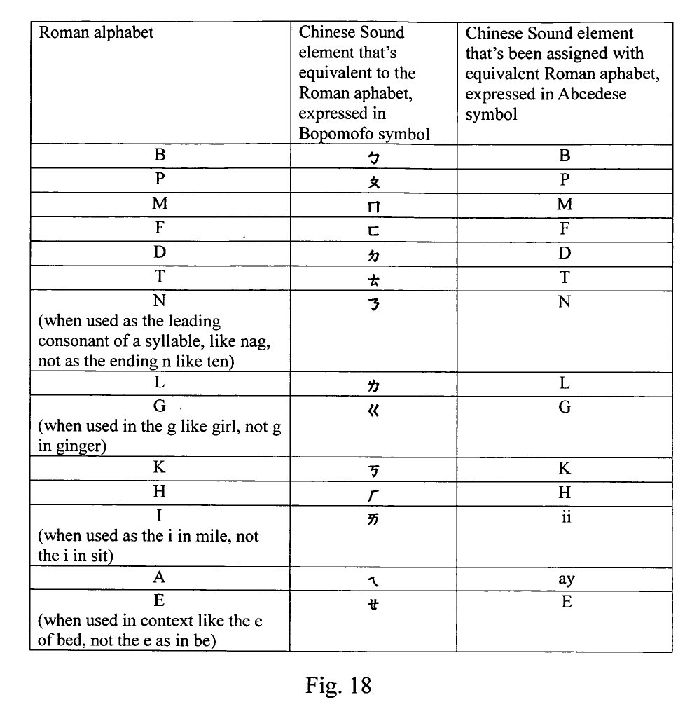

FIG. 18 is the table of the 14 Chinese sound elements that can be represented by Roman alphabets directly.

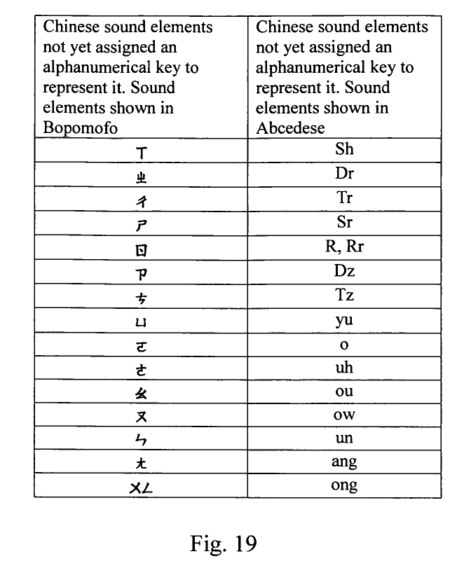

FIG. 19 is the table of the unassigned sound elements.

### DETAILED DESCRIPTION OF THE PREFERRED EMBODIMENT

Integrated Phonetic Chinese System according to a prefer embodiment of the present invention is illustrated; this invention consists of four system modules. They are: system module #1: A Chinese pronunciation key system that defines a set of phonetic symbols representing the Chinese sounds and tones, system module #2: A Chinese Romanization system that defines the rules for transcribing Chinese words into Roman alphabetical scripts, system module #3: An input method that allows users to generate the pronunciation key scripts of module #1, the Roman alphabetical scripts of module #2, as well as regular Chinese characters and system module #4: An advanced input method that utilizes a 24 key position matrix derived from the Chinese pronunciation laws. Due to the extremely small number of keys used, this input method requires minimum movements of fingers and wrists and is therefore extremely fast and efficient.

System module #1 and system module #2 are two different ways to represent the Chinese sounds with symbols. The difference of the two lies in the fact that module #1 symbols are not limited to the Roman alphabets. We designed this module using both alphabetical and the numerical symbols. The purpose of module #1 is to act as a pronunciation keys for Chinese words. It complies with the principle of one-symbol-one-sound-element.

We use specially designed fonts to generate those phonetic symbols used as pronunciation keys.

We call system module #1 ‘Alphanumese’. This name implies that those pronunciation key symbols consist of alphabetical and numerical symbols.

System module #2 is conceived as a Romanized scripting tool. It, therefore, can only use alphabets, not numbers. Our design aim for this module was to make it as compatible with English phonics as possible. Furthermore, we designed a simple yet powerful solution for the generation of the diacritics that designate the tonal information of Chinese words.

We call system module #2 ‘Abcedese’. This name stresses the fact that this is a scripting tool using the 26 basic Roman alphabets (from a to z).

Each of these 2 modules has its important function in helping people to learn and use Chinese language.

System module #1 uses just one single symbol to represent one Chinese sound element.

System module #2 uses one or two or even three alphabets to represent a Chinese sound element. It's because there are only 26 Roman alphabets, yet there are 38 Chinese sound elements. So it is natural that for some sound elements, more than one alphabet is needed to represent the Chinese sound properly.

Since the two modules have different design constraint and different usage, their symbols are naturally not identical.

But we have endeavored to make these 2 modules as compatible as possible. Our aim is that learners and users of these 2 modules would learn any one module and would find it very easy to learn the other module. We have eventually been able to accomplish this important design goal. Our Alphanumese and Abcedese symbol sets are indeed highly compatible.

Before we itemize the features and benefits of our design of those 2 system modules, we first present a comparison table (FIG. 1) of all Chinese sound elements represented in several prior art systems as well as in the symbols of our two system modules. This comparison table includes Bopomofo symbols, Pinyin symbols, prior art #1 symbols, Alphanumese symbols and Abcedese symbols.

For our system module #1 Alphanumese, we shall show two formats of Chinese phonetic symbols.

One is the formal phonetic symbols, which is using special fonts to display the kind of symbols that user would actually see. The other format is the namesake keys that are the text keys (without any specific font associated with them) used to represent the Chinese sound elements.

Examples: [symbol] are our formal Alphanumese symbols, where as B, K, J, A, 3, N are the namesake keys of those formal Alphanumese symbols respectively. Both formats of the symbols are display in the comparison table. The namesake keys are shown in parenthesis.

Note namesake keys are very important in our system as those keys are the very keys to be used in module #3 to actually conduct the inputting of Chinese sound symbols and Chinese words.

Prior art #1 is the predecessor of our Alphanumese. Its symbols are also shown in 2 formats (formal symbols and namesake keys).

FIG. 2 is the comparison table of the tonal marks of Chinese sounds. For prior art #1 both formats, namely the formal symbols with special font and the namesake text keys without any special fonts associated with them, are displayed. Alphanumese and Abcedese do not use namesake keys to represent tonal marks any more. Instead special font technique is used to generate the tonal marks.

FIG. 3 shows Chinese vowel sounds in Alphanumese symbols complete with tonal information encoded. Only vowels can be marked with tonal symbols. It is because only vowels are pronounceable and thus can have different tones associated with them. This is why when discussing tonal marks; the user concentrates only on the vowels of the Chinese sounds. There are 24 Chinese vowel sounds.

Consonants alone cannot be pronounced and thus cannot form a Chinese word. There are 14 such consonants. They are omitted from the table as consonants are not relevant to the tone of a Chinese word.

We listed full phonetic symbols that are implemented with tonal marks. It is worth mentioning that the system achieves the inclusion of tonal information in Alphanumese symbols with the use of several fonts. Each font help generate the symbol for one of the 5 tones.

FIG. 4 shows Chinese vowel sounds in Abcedese symbols complete with tonal information encoded. We use 5 fonts expressing the Abcedese script in all 5 tones in Chinese pronunciation. The special font is applied only to the last alphabet of the whole symbol set (for each sound).

Using special font on a single alphabet of a word is supported by RTF (Rich Text Format) and HTML (the web standard format). Each word processing software program supports at least one of these 2 formats. Therefore our special design for achieving the tonal mark representation can be implemented in every present day computer.

FIG. 5 shows the Bopomofo symbols with tonal information encoded. It is worth mentioning that the Bopomofo way is also very neat and efficient, as is plain to see in above chart. Its only defect is that it is not compatible with English, thus is difficult for English speaking people to learn.

FIG. 6 shows the Pinyin symbols with tonal information encoded. It is worth mentioning that Pinyin system was designed about 40 years ago, before personal computers are widely utilized. So those official symbols with diacritics on top of them were mostly produced in the printing press, not by a software program. This is why those official Pinyin symbols are almost never used, except in dictionaries and in text books.

FIG. 7 shows the prior art #1 symbols with tonal information encoded. The prior Art #1 does not have a solution for representing the light sound. This is one of the most serious defects of Prior Art #1.

If we compare the Bopomofo way and Pinyin way, we'd quickly notice the following:

(1) Bopomofo use stand alone symbols ( [symbol] etc.) to mark the tone level. The tonal marks are always placed at the very end of the vowels (which is also the end of the whole sound representation script).

(2) Pinyin puts the tonal mark on top of the vowel alphabets as diacritics. The resulting pronunciation script looks something like [symbol] ōng or óu. Note now the tonal marks do not fall at the end of the sound any more. It can be the second or even the third to the last alphabet.

This methodology creates a problem that the word boundary is no longer well defined like the Bopomofo symbols. Example: tēng and ān written together becomes tēngān, which is identical with the combination of tēn and gān. It becomes impossible to pronounce tēngān properly since there are 2 ways to pronounce this combined script. In order to fix this bug, Pinyin added another regulation that forces an additional ' (apostrophe) mark in between the connecting words if the second word starts with a vowel. So tēng and ān written together must add a ' to be tēng'ān.

For multi-word Pinyin script, such as diànbīngxiāng (which means refrigerator), the word boundaries are not clear cut. Users cannot intuitively see the demarcation of the words. The reason for this lack of clarity is that the tonal marks are not placed at the end of the word, like Bopomofo symbols.

Our Abcedese symbols always put the tonal marks at the last alphabets of the scripts, such as [symbol] or UN g̅ or O\grave{w}. Note that with our method of generating the tonal marks, the word boundaries are very clearly defined.

There is never any need to add an apostrophe, nor is there any confusion as to where the word boundaries are. This is a major strength of Abcedese over Pinyin.

We can see clearly that our Alphanumese symbols, when fully formed with tonal information is much neater than the symbols of Prior Art #1. Typical Prior Art #1 script is like [symbol] while Alphanumese script is just [symbol] . It is obvious that Alphanumese script is neater.

Without the burden of a namesake key to represent the tone as in Prior Art #1, Alphanumese takes up much less space than Prior Art #1. And its script is much easier to read. So Alphanumese is now much more superior to Prior Art #1 regarding the way tonal marks are formed.

If we further compare fully formed Alphanumese script to all the other 4 systems, we can see that it uses the least amount of space (smallest number of alphabets).

It, therefore, is a superior way to represent the full Chinese sounds (including tone information) with symbols.

After discussing the relative merits of different system regarding the tonal mark issue, we shall start to discuss the most important issue of how Chinese sound elements are defined in Pinyin and in Abcedese and why Abcedese is far superior to the Pinyin ways.

We'll first present the ostensible differences between the two systems, and then we will do a 20 point sound-by-sound comparison and analysis showing the relative strength and usability of the two Chinese Romanization systems.

If we compare the sound element representation scheme between Pinyin and our system module #2 Abcedese, we'd find that among the 38 Chinese sound elements, 18 of them are defined identically. There are 20 sound elements that are defined differently. So we shall limit of our comparison to these 20 sound elements.

We shall first tabulate the ostensible difference in those 20 sound elements, and then we'll demonstrate why our design is much more logical and much easier for English speaking people to learn.

FIG. 8 shows the ostensible difference between the Pinyin symbols and our Abcedese symbols. We use FIG. 9-15 to show the relative strength, weakness, benefit and disadvantage of the above 2 Romanization systems. For each sound element, the tabulation will show following pertinent information:

(a) the sequence number of the sound (this number establishes the link between this chart and the previous definition chart which shows the ostensible differences of the two systems).

(b) the Bopomofo symbol of the sound element

(c) the actual sound that's produced (using English words as pronunciation guideline)

(d) the Pinyin symbol, the typical user response when presented with the specified Pinyin symbols, comments on whether this response is wrong or correct, additional remarks, if any.

(e) the Abcedese symbol, the typical user response when presented with the specified Pinyin symbols, comments on whether this response is wrong or correct, additional remarks, if any.

With above detailed discussion, we have convincingly demonstrated that our Abcedese Romanization method is much better than the Pinyin method. It is much more user-friendly to the English speaking people.

The relationship between our module #1 Alphanumese and our module #3, which we shall call Namesake Input Method is very close.

The link between module #1 Alphanumese and module #3 Namesake Input Method is the namesake keys.

In module #1, the namesake keys used as the base text in special fonts help created the final phonetic symbols that users would see.

In module #3, the exact same namesake keys are used to be the inputting keys. This is doubtlessly the most logical design, as the sound symbols that users see repeatedly would enhance their familiarity of the input keys, thus help them learn to use the Namesake Input Method. And the actual use of the Namesake Input Method help the users to remember the symbols of Chinese sound elements more. Our integrated design thus created two mutually reinforcing modules for users to learn and use.

Bopomofo based input methods do not have this benefit because Bopomofo symbols are non-Roman. The correlation between keys and the Chinese sound elements have to be memorized by brute force.

In our holistically designed system, namesake keys of the sound elements and the input keys are identical. Users learn the symbols and then know input method automatically. This is the ingeniousness of our design. It makes our system extremely easy to learn.

Now we talk about the compatibility between Abcedese and Alphanumese and the way Alphanumese symbols are derived. For achieving maximum compatibility between those 2 phonetic modules we designed Alphanumese after Abcedese is fully defined. Now we discuss how we completed the designing of Alphanumese and how we achieved maximum user-friendliness for English speaking people and maximum compatibility with our Abcedese system.

We shall start with the discussion about the theoretical foundation of the design of Alphanumese.

The process with which we design the Alphanumese is to follow 4 principles that allow the symbols and the actual Chinese sound elements to be related in the minds of the English speaking people.

Principle #1: The use of number keys as symbols for Chinese sounds:

We found out, first of all, that a few Chinese numbers are pronounced with some important sound elements: they are:

Number 1: pronounced with a single vowel sound

[symbol]

Number 2: pronounced with a single vowel sound

[symbol]

Number 4: pronounced with a single vowel sound

[symbol]

Number 5: pronounced with a single vowel sound

[symbol]

It is plain to see that if we use above 4 numbers (1, 2, 4, 5) to represent the sound [symbol] the users would easily remember this connotation.

We further realized that we can try to use more of the numbers to represent some of the Chinese sound elements. The logic is quite simple: whoever that wants to learn Chinese language, the first thing first he/she would do is possibly to learn how to count. So the first ten Chinese words most learners of Chinese would ever learn may be the numbers 0,1,2,3,4,5,6,7,8,9. Anyone who refuses to learn to count in Chinese probably doesn't really have the intention to learn Chinese.

Anyway, to say that ‘learning to count 0 to 9 in Chinese’ is a perquisite for using the Alphanumese system would likely be widely accepted to all Chinese learners.

Having established the feasibility of using Chinese way of counting from 0 to 9 to help with our pronunciation key system, we shall then analyze how far we can go. We need to know how many numbers are truly useful to our cause in this regard.

Let's use the table shown in FIG. 16 to explain the pronunciation of those 10 numbers. We used two sets of symbols (Bopomofo and Abcedese) to designate them.

This pronunciation information would certainly give us the inspiration and the clue to make use of the principle #1.

Number 1: very suitable for representing [symbol] (or i in Abcedese) as the pronunciation of 1 and [symbol] (or i in Abcedese) are identical

Number 2: very suitable for representing [symbol] (or er in Abcedese) as the pronunciations of 2 and [symbol] (or er in Abcedese) are identical

Number 4: very suitable for representing [symbol] (or Sz in Abcedese) as the pronunciations of 4 and [symbol] (or Sz in Abcedese) are identical

Number 5: very suitable for representing [symbol] (or u in Abcedese) as the pronunciations of 5 and [symbol] (or u in Abcedese) are identical

Number 3: suitable for representing [symbol] (or an in Abcedese) as the pronunciation of 3 rhymes with [symbol] (or an in Abcedese)

Number 7: suitable for representing [symbol] (or Ch in Abcedese) as the pronunciation of 7 starts with the consonant [symbol] (or Ch in Abcedese)

Number 8: suitable for representing [symbol] (or a in Abcedese) as the pronunciation of 8 rhymes with [symbol] (or a in Abcedese)

Number 9: suitable for representing consonant [symbol] (or J in Abcedese) as the pronunciation of 9 starts with the consonant [symbol] (or J in Abcedese)

Number 0: suitable for representing vowel [symbol] (or ung in Abcedese) as the pronunciation of 0 thymes with [symbol] (or ung in Abcedese)

Finally, we've found 9 suitable number keys to represent 9 Chinese sound elements. We tabulate the scheme for those numbers used as pronunciation keys in FIG. 17.

Principle #2 Using compatible Roman alphabets directly as Chinese sound elements:

There are a few cases in which the Roman alphabets directly correspond to Chinese sound elements. Naturally we'll take these obvious sound assignments: FIG. 18 shows the 14 Chinese sound elements that can be represented by Roman alphabets directly.

We have thus defined 14 more alphabets to represent 14 Chinese sound elements in Alphanumese. Now we have satisfactorily defined a total of 23 Chinese sounds elements in Alphanumese using principle #1 and #2.

There remain only 15 sound elements not yet assigned with an easy to remember alphanumerical keys. We tabulate those 15 sound elements in FIG. 19. They are shown with Bopomofo symbols and Abcedese symbols and Pinyin symbols for our easy reference. Our remaining task is to find good alphanumerical symbols to represent those 15 sound elements.

Principle #3: using keys that are compatible with Abcedese symbols:

Now our approach is to use ‘designing Alphanumese to be compatible with our Abcedese symbols’ as a design guide line. By sticking to this principle we can use existing Abcedese symbols to help user remember the Alphanumese symbols. By strictly following this guide line, we derived following sound assignment scheme:
1. Sound element [symbol] : Now assigned with the alphabet u in Alphanumese.
   Reason: in Abcedese, the [symbol] sound is represented by ou. The alphabet u and ou used in Abcedese are compatible.
2. Sound element [symbol] : Now assigned with the alphabet w in Alphanumese.
   Reason: in Abcedese, the [symbol] sound is represented by ow. The alphabet w and ow used in Abcedese are compatible
3. Sound element [symbol] : Now assigned with the alphabet o in Alphanumese.
   Reason: in Abcedese, the [symbol] sound is represented by o. The alphabet o and the o used in Abcedese are identical.
4. Sound element [symbol] : Now assigned the alphabet h in Alphanumese.
   Reason: in Abcedese, the [symbol] sound is represented by uh. The alphabet h and uh used in Abcedese are compatible.
5. Sound element [symbol] : Now assigned the alphabet y in Alphanumese.
   Reason: in Abcedese, the [symbol] sound is represented by yu. The alphabet y and yu used in Abcedese are compatible.
6. Sound element [symbol] : Now assigned the alphabet R in Alphanumese.
   Reason: in Abcedese, the [symbol] sound is represented by R, Rr. The alphabet R and R, Rr used in Abcedese are compatible.
7. Sound element [symbol] : Now assigned the alphabet n in Alphanumese.
   Reason: in Abcedese, the [symbol] sound is represented by un. The alphabet n and un used in Abcedese are compatible.
8. Sound element [symbol] : Now assigned the alphabet g in Alphanumese.
   Reason: in Abcedese, the [symbol] sound is represented by ang. The alphabet g and ang used in Abcedese are compatible.
9. Sound element [symbol] : Now assigned the alphabet z in Alphanumese.
   Reason: in Abcedese, the [symbol] sound is represented by Dz. The alphabet z and Dz used in Abcedese are compatible.
10. Sound element [symbol] : Now assigned the alphabet S in Alphanumese.
   Reason: in Abcedese, the [symbol] sound is represented by Sr. The alphabet S and Sr used in Abcedese is compatible.

Note here the use of g and n is identical with previous assignment based on Principle #2 (Using compatible Roman alphabets directly as Chinese sound elements). Luckily this dual assignment is allowed because of the law of reusability of Al subgroup namesake keys for group C namesake keys as discussed previously.

Now with the compatibility between Alphanumese with Abcedese as the guiding principle, we have successfully assigned above 10 more Chinese sound elements, using 10 alphabets.

The total number of assigned Chinese sound element is now 33. We have just 5 more Chinese sound elements to assign. And they are [symbol] and we have 5 alphabets not assigned yet. They are C, J, Q, X, V.

Principle #4: use alphabets compatible with other prior arts, such as Pinyin and prior art #1.

We decide to assign Chinese sound [symbol] to alphabet X, and Chinese sound [symbol] to alphabet C. Such assignment is following the convention of prior art Pinyin.

And we proceed to assign [symbol] to alphabet J because the lip shape of the pronunciation of [symbol] and alphabet J is similar. This is also the assignment scheme of prior art #1.

We proceed to assign [symbol] to alphabet Q. This is the assignment scheme of prior art #1.

There is now only one sound left and one alphabet to go. So there is no more choice to do. We assign [symbol] sound to the final alphabet V.

Thus we completed our design of a Chinese pronunciation key system. We believe this Chinese sound assignment scheme is the best there can ever be. 33 of the 38 sound elements are intimately related to the symbols assigned and, thus, are easy to learn and remember for English speaking people. Four more assignments are following prior art convention. And one last sound is using the only remaining alphabet V.

Those namesake keys are ostensibly Roman alphabets and numbers. But the true essence of those namesake keys, used in Alphanumese, is that they are Chinese sound elements. To emphasize the Chinese nature of those namesake keys, we designed special fonts for them. The special fonts give more clues to user than the simple namesake keys. Those namesake keys shown in special fonts are the actual symbols that users would see.

We show below the Alphanumese symbol sets in the special fonts that we designed. We will explain the special phonetic traits conveyed by those symbols later.
1. Group A1 symbols: [symbol] [symbol] which corresponds to [symbol] [symbol] in Bopomofo.
2. Group A2 symbols: [symbol] which corresponds to [symbol] in Bopomofo.
3. Group B symbols: [symbol] which corresponds to [symbol] in Bopomofo.
4. Group C symbols: [symbol] [symbol] which corresponds to [symbol] [symbol] in Bopomofo.
5. Group D symbols: In Alphanumese the tonal marks (group D symbols) are shown with special symbols formed by various fonts. Full Alphanumese symbols with tonal marks encoded are shown in FIG. 3.

As shown above clearly, we have given each group of Chinese sound elements a special group identification mark in the symbol itself. Here is the explanation of the group identification mark.
(1) For group A1 sound elements, a dot is added down the main symbol, as in [symbol]
(2) For group A2 sound elements, 2 dots are added down the main symbol, as in [symbol]
(3) For group B sound elements a flat bar plus a raised center part is added down the main symbol, as in [symbol]
(4) For group C sound elements a flat bar is added down the main symbol, as in

[symbol]

These visual aids would help users and learners to know the nature of each Chinese sound element. In the background section we've discussed the grouping of Chinese sound elements. We further list here a few important traits of each of the groups (including subgroups):
Group A: are always at the beginning of a sound representation. Those sound elements are consonants, though subgroup A2 can act as vowels too.
Group B: linking vowels, or medials in Chinese language nomenclature. Those sound elements are vowels. It's the only group of sounds that could have a consonant before it and a vowel after it.
Group C: The main vowels. It is always the last sound element of a Alphanumese sound representation (if the sound contains the group C vowels).
More about group A: within group A, there are two sub-groups of sound elements. They have very distinctive traits.
Group A1: Those are the genuine consonant. They cannot be pronounced alone. No Chinese word is formed with these consonants alone.
Group A2: Group A2 can act as both consonants and as a vowel. There are many Chinese words that are pronounced solely with a single sound element of this A2 group.

Note by providing those pertinent grouping identification information with the symbols, we enable Alphanumese users to remember and identify those sound elements much faster. It's the classical ‘divide and conquer’ strategy. It breaks down the learning task to 4 sub-tasks and thus helps learners to learn faster.

Therefore, in a real sense, our Alphanumese system is superior to the original Bopomofo ways, besides the fact that our symbols are Roman by nature. Our symbols contain the important grouping information whereas Bopomofo symbols do not.

This Alphanumese pronunciation key system is, therefore, a most easy-to-learn and easy-to-remember Chinese pronunciation guide for English speaking people.

System Module #3—The Namesake Input Method:

Let's first explain what is a namesake input method? What's so special about this input method? What benefits does it have that existing hundreds of Chinese input methods cannot achieve?

English speaking people, until now, has one way to do Chinese input—using Pinyin. As discussed above, Pinyin is very cumbersome. In many cases it requires 3 key strokes (a-n-g, e-n-g, o-n-g) to represent a single sound element. Many other sound elements, such as zh, ch, sh, an, en, ai, ou, ei, ao . . . , require two key strokes to designate.

Using more than one stroke to designate one sound element is inherently inefficient.

Also it is difficult to remember those rules and regulations of Pinyin because Pinyin does not follow one-symbol-one-sound principle.

Besides, all existing Pinyin-based input methods, unlike Bopomofo input method used in Taiwan, do not use the tones to differentiate Chinese words. For example: when user wants to input a Chinese word with the pronunciation of [symbol] (Alphanumese) [symbol] (Bopomofo) [symbol] (Abcedese) [symbol] (Pinyin). In Pinyin input method, user enters wang then there is no longer a way to specify tone 3.

The net result is that user has to pick from all the Chinese words that has the same pronounced sound but with different tones. This practice normally increases the candidate words for user picking by about four folds because there are 4 main tones in Chinese language and one less used light sound.

Picking a word out of a large collection is not as easy as picking it out from a very small collection. It's plain to see that Pinyin input method is not efficient in this regard.

With Bopomofo input method, user can enter a final tone key and get only words with the correct sound down to the level of one single tone. This practice reduces the size of the final word list for picking.

It is therefore obvious to see that the Pinyin way is inferior to the Bopomofo input method. It needs much more key strokes and it cannot allow user to specify the tone of intended Chinese word.

But since Bopomofo system is not using Roman alphabets, it is not compatible with English speaking people. So, there is no good solution yet for English speaking people to do Chinese input.

We believe an ideal input method for English speaking people should strive to implement following features:
1. User can use one key stroke to designate one sound element, not using multiple keys. Pinyin input method fails in this regard.
2. User should be able to specify the tone of the intended input word so that the resulting candidate word list would be most targeted, and thus easy to pick. Pinyin fails in this regard.
3. User can do normal English input/editing and Chinese input/editing at the same time without key press to switch between Chinese input mode and English editing mode. In almost all the Chinese input methods in the world, this has never been implemented.
   The most typical key-combination to do the switching (between a Chinese input mode and an English editing mode) is ctrl-space, which is a two-key operation.
   Suppose someone wants to write a single Chinese word in an English sentence, he/she needs to do a two-key operation to switch into Chinese mode, do the input, and then do another two-key operation to switch back to English mode. It is plain to see the inefficiency of such excessive mode-switching.
4. The symbols to be used should have high affinity to English speaking people. The Bopomofo system fails in this regard. It is totally incompatible with English.
5. The key assignments for the Chinese input should be very easy to understand and remember for English speaking people.

We have studied this subject very thoroughly, with above 5 criteria in mind. We derived following conclusions:
1. First we need to design a pronunciation key system. The symbols should be alphanumerical and thus easy to remember for English speaking people. This has been achieved with our module #1 Alphanumese. Alphanumese is fully compatible with English. So design aim #4 is satisfied. Design aim #4 is where Bopomofo fails. It isn't compatible with English.
2. Alphanumese is a one-symbol-one-sound system. So by using Alphanumese the design aim #1 is satisfied too. Design aim #1 is where Pinyin method fails to achieve because it requires multiple key pressing for many of the Chinese sound elements.
3. We then need to design an input method that's running in the background of the computer monitoring user's key strokes. This program would watch 5 particular keys. If one of those 5 particular keys is pressed, then the system would analyze the previous few keystrokes and decide whether the user entered ‘a valid Chinese sound’. If the answer is positive, then the system would then display a pop-up window and present a ‘Chinese Word List’ for user to pick and thus complete the inputting.

And after user made the choice from the Chinese word list, the system would first backspace a few times, erasing the just typed Chinese-input-keys. And then the system would paste the selected Chinese word into the document completing the inputting process.

This method enables the user to enter English and Chinese simultaneously without having to enter a Chinese-entering-mode to do the Chinese input. This approach, thus, fulfill the design aim #3. Design aim #3 is a function that none of existing input method ever achieved. It's an innovational approach to Chinese input.

Also this method does make use of the tonal marks. It therefore fulfills the design aim #2, which Pinyin was unable to do.

By the way, the 5 particular keys that our inputting system would watch are the activating keys that represent one of the possible Chinese tones. The concept of this design is simple: each Chinese pronunciation script must end with one of 5 tones. So these 5 keys are acting as the litmus test. Without any of those 5 keys, the typed script could never be a Chinese pronunciation script. Therefore, only when user pressed one of those 5 keys would system starts to analyze what user has typed prior to this activating key.

Since the input key assignment is identical to the Chinese symbol assignment. User has no extra memory burden trying to remember which key to press to mean a certain Chinese sound. This is where our input method is superior to the Bopomofo input method. There are so many layouts available and each such layout requires mechanical remembering by the users. Our method, thus, fulfills the design aim #5 most satisfactorily. This design aim #5 is making our method far superior to both Pinyin and Bopomofo input methods.

After our above preliminary analysis we found out that the challenge of the actual design is just to find 5 keys that are easily reachable (meaning not high up on the keyboard to be difficult to reach) but are not likely to be used in normal English editing process. Initially we've found only 3 of such keys, namely the semi-colon (;) key, the left-bracket ([) key and the right bracket (]) key.

Above 3 keys are really rarely used in normal English editing. But all the other keys are not in this category. We've made pilot programs to test and concludes that in normal English editing process, keys like comma, period, forward slash, apostrophe (') are still quite likely to be used.

But to make this input method work, we need to come up with 2 more keys that can't possibly be used in any English editing environment. Finally we made the breakthrough by being really creative. We realize that the left shift key and right shift key can serve our needs perfectly well. The reason is: those two keys are never used as a standalone key. Its typical use is that user press and hold the shift key, type another key, then release the shift key to complete the typing of a shifted-key entry.

However we found out that the computer operating system does allow the tracking of the pressing and releasing of the shift key as two separate event. And we can easily write codes to differentiate a normal shifted-key press or just a plain key press of the shift key, just like the pressing of any other key.

We did our experiments and the result conforms to our theory. We are able to use these two shift keys as the activating keys for Chinese input, each key represent one of the 5 tones of the Chinese words.

To sum up, we successfully found 5 keys that are easy to access (the 2 shift keys are especially easy to access. They are twice as big as the normal alphabetic keys) yet almost never used in normal English editing. We use them to act as the activating keys, each designating one of the 5 tones of Chinese word. Thus we completed the design of the Namesake Input Method.

In the extremely rare cases that user are typing normal English words and accidentally used the semi-colon key or left bracket or right bracket, the system would consider it an activating key stroke. The system would then evaluate the previous few key strokes and check whether the whole keystroke sequence constitutes a legitimate Chinese input.

The chance that the answer would be positive is very rare indeed because there are only 500 or so alphanumerical combinations that would constitute a Chinese sound.

And if such a thing happens, and the pop-up Chinese word list is displayed, users can simply press an Esc key to cancel this pop-up window. So there is an easy solution to such rare occasions.

The techniques involved in making this software work as envisioned are listed below:

1. Software must maintain following data:

(a) A database of all Chinese sound, indexed in Alphanumese symbols. The other data fields include corresponding Abcedese symbols.

(b) A database of all traditional Chinese characters and Simplified Chinese characters, indexed in Alphanumese symbols. The data stored per each Alphanumese symbol set can be multiple Chinese characters. It's because in Chinese language there exist a lot of homophones. So each valid Chinese sound could correspond to multiples characters.

2. Software, while running, must keep track of user input in a buffer area. After each user key stroke, a software routine would evaluate that key stroke. Two possible scenarios can follow, as shown below:

(a) if the key pressed is one of the 5 tonal mark namesake keys:

Then the last input key is added to the user input buffer. And then this resulting data is compared to the index of the above databases. If a match is found, the program would enter ‘output procedure’. If a match is not found, then the program flush the user input buffer and wait for further input.

(b) if the key pressed is not one of the 5 tonal marks namesake keys: Then program would check whether the key are one of the following keys,

(1) Space key

(2) Delete key, Insert key

(3) Esc key, backspace key, all cursor movement keys

(4) all punctuation and function keys (except the 5 namesake keys of the tonal marks of Alphanumese)

If the pressed key is indeed among them, then it means this key is not a continuation of a unfinished Chinese sound. Therefore the user input buffer is flushed and program waits for next input.

If the key pressed is not among those keys, then this is considered the first key or the continuation of a Chinese sound input. Thus this key value is added to the queue of user input buffer.

3. The output procedure has two main branch of operation, depending on users' preset options. Two possible program flows will play out.

(a) If user selected output option 1 and option 2, then the output is a ‘symbol set designating a Chinese sound’. The program will then backspace multiple times to remove the typed keys. Then program will paste into the underlying program (such as Word, Outlook) the selected sound in specified format (one of two possible format: Alphanumese or Abcedese)

(b) If user selected output option 3 or 4, then the output is to be a Chinese character. Following program action will ensue:

(1) Program will display all the Chinese characters that is pronounced in that particular sound. The display would be done in the form of a popup window. A matrix will show all those characters for user to choose.

(2) User can either enter the row and column number of the selected Chinese character. Or he/she can press Esc to abort this input operation.

(3) If user selected the Chinese character, then program will backspace multiple times to erase the entered keys. Then program will paste into the underlying program (such as Word, Outlook) the selected Chinese character and complete the input process.

4. The innovative approach we invented in this Namesake Input Method:

Previously all the Chinese input method would allow user to enter ‘Chinese character as a text input’, Our Namesake Input Method is doing a different type of input. In order to generate the sounds symbols with tonal marks, we have to use special ‘pasting’, which is using the Windows clipboard as the medium to conduct a ‘clipboard content paste’ into the underlying program. This Windows clipboard allows RTF data and HTML data to be stored. Both formats allow font to be individually defined up to the alphabet level. So a word that consists of say 3 alphabets, it is now possible to specify 3 different fonts to the 3 alphabets. This technique allowed us to succeed in creating the input of sound symbols, which do use multiple fonts on a pronunciation script, or on a Romanized script.

Each and every word processing program would support either RTF or HTML format (most support both formats). So our input method would work with all the word processing programs successfully. Actual program codes have been written and it is confirmed that our Namesake Input Method works flawlessly.

The superiority of our first 3 system modules (module #1, module #2 and module #3) over prior arts:

A. The superiority of Alphanumese (module #1) over prior arts:

1. As compared to Bopomofo:

(a) Alphanumese is superior to Bopomofo, because it uses Roman alphabets and numbers as sound element symbols, thus it is much easier for English speaking people to learn and remember.

(b) The standard symbols of Alphanumese are showing the individual group identification mark of each sound element. Such pertinent information is not shown on Bopomofo symbols.

2. As compared to prior art #1:

(a) Alphanumese has a unique symbol for each of all 38 unique Chinese sound elements, while prior art #1 has only 37 unique symbols. In prior art #1, one unique sound element [symbol] or [symbol] in prior art #1) has to be represented by a two-symbol composite. This is not convenient and it can cause confusion to learners, since the same symbol can be pronounced differently in some occasions.

(b) For Alphanumese, of the 38 unique sound elements, 33 of them can be phonetically connected to English alphabets, or numbers as pronounced in Chinese, or to Abcedese symbols, which themselves are compatible with the English phonics convention. Only 5 out of 38 symbols (namely [symbol] or [symbol] in Alphanumese) have to be remembered without any phonetic anchor.

For prior art #1, out of the 37 sound elements, aside from the above 5 sound elements that are not without phonetic anchor, there are 5 more sound elements, namely ( [symbol] ) are without phonetic connotation, requiring learners to remember them the hard way. So our Alphanumese is a much easier to learn than prior art #1.

(c) Alphanumese is designed to be compatible with a Romanization scheme Abcedese in mind, while prior art #1 is not. Alphanumese users get memory reinforcement from a compatible Romanized script Abcedese, while prior art #1 users do not.

(d) The tonal marks of Alphanumese is much more advanced than the tonal mark symbols of prior art #1 ( [symbol] ). It is much simpler.

The practice of Alphanumese to put these tonal marks on the top part of the vowel symbols is in tune with the convention of Roman diacritics and is, therefore, more familar to the Roman language users, including English speaking people.

(e) The design of Alphanumese has a goal to develope a totally compatible namesake Chinese input method, while prior art #1 does not. Therefore the user of Alphanumese can learn to do Chinese input within minutes after he/she learned the Alphanumese symbols, while prior art #1 users cannot.

3. As compared to Pinyin:

There is actually no comparison. Pinyin does not qualify as a properly designed pronunciation guide for Chinese as it is not following one-symbol-one-sound principle.

Alphanumese is designed as a pronunciation guide. It is for phonetization of Chinese, not for Romanization of Chinese. The two systems do not belong to the same catagory. So there is no need for the comparison.

B. The superiority of Abcedese (module #2) over prior arts:

1. As compared to Bopomofo

Bopomofo is not using Romanized script. It is not a Romanization system for Chinese. There is no comparison between Abcedese to Bopomofo.

2. As compared to Prior Art #1

Prior Art #1 is a pronunciation key system for Chinese. It is not a Romanization system for Chinese. There is no need to compare the two systems which are in different category

3. As compared to Pinyin

(a) Abcedese is superior to Pinyin in the assignment of sound elements to symbols. We have tabulated 20 sound elements where Abcedese is far superior to Pinyin

(b) Abcedese use only 26 basic Roman alphabets while Pinyin used a lot of diacritics that are almost impossible for users to generate. So Abcedese is superior

(c) The Abcedese way of showing the tonal marks is simple and elegant and very easy to learn and use. The Abcedese way of showing the tonal marks in the last alphabet of a script enables users to clearly see the demarcation of Chinese words. Pinyin does not give clear demarcation of Chinese words.

(d) Abcedese has a compatible phonetizaion system, namely Alphanumese to go with it together as a total solution. Pinyin has to use itself as a phonetization system, which is totally inadequate.

(e) Abcedese is integrated with the namesake input method. It is among the supported output options of the Namesake Input Method. So user can generate a properly written Abcedese script by typing much less key strokes. Example: the full Abcedese script [symbol] requires just 3 key strokes (namely j g ;) to write, while an equivalent Pinyin script Zhang (without tonal mark) requires 5 strokes (namely Z h a n g) to write. And actually there is practically no easy way any one can generate a full Pinyin script zhang. So writing Abcedese script takes much less strokes yet shows more information in the script (complete with tone marks).

C. The superiority of namesake Chinese input method (module #3) over prior arts:

1. As compared to Pinyin based input methods:

(a) Our namesake input method uses much less key strokes. Example: for inputting Chinese word [symbol] Our users needs press 3 keys to fully define the Chinese sound of this word. The same word, in Pinyin, needs 5 strokes to define.

(b) For Pinyin-based input methods, the tonal features of Chinese sounds are not used. The Chinese word list would appear without users' specifying of the tone of a sound. Users have to pick from a very big pick list.

This is making the picking of words much more difficult. Now Chinese words of same sound but different tones would be lumped together for user's picking. Many more navigational key strokes are needed to arrive at the exact word that user want to input. So Pinyin-based input methods are inefficient.

(c) Pinyin method, like all other input methods, would only allow user to generate the formal Chinese characters. None of such input methods allow the inputting of pronunciation keys or fully formed Romanized scripts.

Our namesake input method allows all 3 types of scripts to be generated, namely the pronunciation key symbols (Alphanumese), the Romanized scripts (Abcedese) and the formal Chinese characters.

Such extra feature is extremely useful for English speaking learners of Chinese. Before they can learn to input the formal Chinese characters, they can do the inputting of both the pronunciation key symbols and Romanized scripts (both fully fitted with tonal marks). This is an important tool for Chinese learners in their initial stage of learning Chinese.

(d) Since Namesake Input Method uses the same keys that are the namesake keys of Chinese sound elements as the inputting keys, the very action of inputting will strengthen the affinity of users to the sound symbols themselves. This way the user is doing the learning while doing the inputting. It's most economical for Chinese learners to learn and use Chinese at the same time.

2. As compared to other Chinese input methods:

Note our Namesake Input Method is designed to help English speaking people to learn and use Chinese. Its main goal is to give them an integrated system much better than Pinyin.

We did not intend to convert each and every Chinese to use this method. Therefore it is pointless to compare this method to all the existing Chinese input methods.

As far as input method is concerned, we think only Pinyin-based methods are relevant to this invention and the comparison is done above.

System Module #4—the 24 Key Position Input Method:

First of all, since we already have a great new input method—Namesake input method, why is there the need of another input method?

The answer is yes there is a need for another advanced input method that's concentrating on fastest possible Chinese inputting. When people become proficient in Chinese language they'd feel the need to do Chinese inputting as fast as possible. And this module #4 is designed to provide the fastest possible Chinese inputting using many different keyboards or keypads.

The efficiency of Chinese inputting depends a lot on how the fingers and the wrists move. If the total number of keys to be used is smaller, then fingers move less and the wrists move less and efficiency increases. The quest of most efficient input method is, therefore, equivalent to finding an input method that utilizes least number of the keys.

To achieve the least number of keys for an effective Chinese inputting we need to have breakthrough theory.

We achieve the breakthrough theory through following reasoning:

Note that we've discussed the 7 laws that govern the pronunciation of Chinese words. And we've derived the corollary that says: the group A1 consonant namesake keys can be used as the namesake keys of the group C vowels.

And we did use that corollary in our Namesake Input Method (module #3) and reused 3 keys, namely g, l, n to designate the Group C sound elements.

But we found out that the aforementioned corollary of the 7 laws can be exploited further to derive a most efficient input method, using least number of keys.

On more careful study of this most important language trait of Chinese, we came to an even more powerful conclusion. Based on this incredible conclusion we are able to resolve of our main design goal—to use minimum number of keys for inputting.

Note that in Alphanumese (module #1) and Namesake Input Method (module #3) we use 26 English alphabets (a to z) plus 9 of the numbers to represent the Chinese sound symbols. That idea was depending on the mental connection of the symbols themselves to represent the Chinese sound. For example, the number 5 was used to represent the sound [symbol] and the number 7 was used to designate sound [symbol] all because those numbers are pronounced in Chinese language just like the respective sound elements.

So the connection we intended and achieved was a connection between the key symbols themselves and the actual sound elements. The essence is symbols-to-sounds.

The breakthrough happens when we invoke the same corollary of the 7 laws not using a symbol-to-sound connection, but rather a position-to-sound connection.

After prolonged study, we perfected this alternative approach and succeeded in utilizing above concept to design a series of input methods, using different keyboard/keypad environment.

All those methods are based on a single 24 key position matrix of Chinese sounds. We shall derive this 24 key position matrix hereby.

As we explained in previous patent application, there are 38 unique Chinese sound elements, they are:

[symbol]

[symbol]

[symbol]

[symbol]

[symbol]

[symbol]

We deem the sequence of the 38 Chinese sound elements as important as the sequence of the Roman alphabets from a to z.

The module #4 of our present invention is built upon this important Chinese Sound Sequence.

According to the grouping principle, those 38 sound elements are grouped according to following scheme:

Group A1:

[symbol]

[symbol]

Group A2:

[symbol]

Group B:

[symbol]

Group C:

[symbol]

[symbol]

The breakthrough that eventually leads to the invention of our module #4 (24 Key Position Input Method) happened when we decided to present the 38 Chinese sound elements in following matrix manner.

| | 1 | 2 | 3 | 4 |
|---|---|---|---|---|
| 1 | [symbol] | [symbol] | [symbol] | [symbol] |
| 2 | [symbol] | [symbol] | [symbol] | [symbol] |
| 3 | [symbol] | [symbol] | [symbol] | |
| 4 | [symbol] | [symbol] | [symbol] | |
| 5 | [symbol] | [symbol] | [symbol] | [symbol] |
| 6 | [symbol] | [symbol] | [symbol] | |
| 7 | [symbol] | [symbol] | [symbol] | |
| 8 | 8 | O | h | e |
| 9 | I | A | U | W |
| 10 | 3 | n | g | |
| 11 | | V | 2 | |

Now we can see clearly that the 14 symbols of group A1 and the 14 symbols of group C are of identical pattern (4-4-3-3). According to previously derived corollary of the 7 laws the symbols used in Group Al can be re-used in Group C. This is such a unique feature of Chinese language that we will now find it extremely handy in our design of a position-based input method (in contrast to the symbol-based inputting method).

Now if the symbols of Group A1 and Group C can be re-used, due to the fact that their relative position in a pronunciation key script can never overlap, we can also assign the group C elements the same position of group A1 position (because elements of these two separate groups can never be mixed up in an actual pronunciation key script).

We call this conclusion: “The law of superimposition of group A1 sound elements and group C elements”. Those 2 groups of sound elements can share same key locations with no fear of confusion. This is technically another corollary of the 7 laws of Chinese pronunciation.

With above conclusion, now we can do the superimposition and rearrange the Chinese sound element matrix like this:

| | 1 | 2 | 3 | 4 |
|---|---|---|---|---|
| 1 | [symbol] 8 | [symbol] O | [symbol] h | [symbol] e |
| 2 | [symbol] I | [symbol] A | [symbol] U | [symbol] W |
| 3 | [symbol] 3 | [symbol] n | [symbol] g | |
| 4 | [symbol] | [symbol] V | [symbol] 2 | |
| 5 | [symbol] | [symbol] | [symbol] | [symbol] |
| 6 | [symbol] | [symbol] | [symbol] | |
| 7 | [symbol] | [symbol] | [symbol] | |

Note for effective Chinese inputting, there must be keys for the 5 tones of Chinese sounds. Now we shall derive another amazing corollary of Chinese pronunciation based on the 7 laws.

According to Law #4, group A1 elements can only be at the beginning of a pronunciation key script. It can never to at the 2^{nd} place, nor 3^{rd} place, nor the 4^{th} place.

And according to Law #4, Group D symbols would always fall at the end of the pronunciation key script. It can never fall on the first place.

Combining these 2 observations, we deduct follow conclusion: “The keys used for group A1 and the keys used for group D (the tone indication) can use the same symbols or locations in a matrix. There can never be confusion”.

For example, if one key location is assigned to designate both a Group A1 element [symbol] as well as a group D element (tone 1), we can easily decide whether user's keystroke is [symbol] or tone 1. When user is typing the first sound element of a Chinese sound and he/she pressed that particular key, then it must be [symbol] And when it is the 2^{nd} or 3^{rd} or 4^{th} key press of a particular pronunciation key script, then it must be tone 1.

We call this conclusion: “The law of superimposition of group A2 elements and group D elements, which is the tone of a Chinese sound”. It is another corollary of the 7 laws of Chinese pronunciation. Note this law was never invoked in prior art #1. It is the technical breakthrough of current invention.

With this law in place, we can now further refine our Chinese sound element matrix to be like this:

| | 1 | 2 | 3 | 4 |
|---|---|---|---|---|
| 1 | [symbol] 8 | [symbol] O | [symbol] h | [symbol] e |
| 2 | [symbol] I | [symbol] A | [symbol] U | [symbol] w |
| 3 | [symbol] 3 | [symbol] n | [symbol] g | |
| 4 | [symbol] | [symbol] V | [symbol] 2 | |
| 5 | [symbol] - | [symbol] [symbol] | [symbol] [symbol] | [symbol] [symbol] |
| 6 | [symbol] • | [symbol] | [symbol] | |
| 7 | [symbol] | [symbol] | [symbol] | |

This final form of Chinese sound element matrix is the foundation of all the methods and devices that we designed in this invention. It has just 24 cells. Yet it can designate all 38 Chinese sounds and all 5 tones. We consider each cell location (row number and column number) as a position reference. So we call it ‘The 24 key position Chinese sound matrix’. A simpler way to refer to this matrix is ‘24 key position matrix’.

Actually the implication of this matrix is immense. In keyboard-based Chinese input, we can say it's a “24 key position matrix”. In a virtual keyboard application such as the touch screen type of inputting used in iphone, we can apply the same matrix and in that case it is a ‘24 virtual key position matrix’.

Accordingly, the virtual keyboard can be a numerical keypad or the keypad on a handheld device that only has numerical keys and no alphabetical key, which uses two key pressing of the virtual keyboard to represent one key stroke that conforms to the “24 key position Chinese sound matrix as expressed in standard matrix cell location format”.

Its essence is that: user just need 24 different ways to differentiate his/her intended sound elements to be able to get his/her intended Chinese sound across, either through a keyboard-based software method, or touch screen virtual keypad method or any other ways.

The general guide line for defining an input method is to define 24 elements (whether through symbols, numbers, screen touching, hand signs, finger signs or any other conceivable signs). Here the term ‘input method’ has an expanded meaning covering any sign or symbol language that corresponds to the 38 Chinese sound elements and 5 tones.

Accordingly, the virtual keyboard can be an imaginary keyboard operated by an audible or perceivable action, wherein the actions are used as the means to convey two digit numbers as shown on said “24 key position Chinese sound matrix as expressed in standard matrix cell location format”. The action can be the successive knocking on a pipe or the successive flipping of a mirror or pre-defined hand signs, finger signs or touch-screen signs.

In this sense the ‘input method’ actually refers to the way one person express his/her intended Chinese sound elements and tones to Chinese inputting software or directly to another person.

The exact meaning of this system module is that: if an instance is defined as a way to express one's intended Chinese sound element, then a working system for that person to express full Chinese sound effectively requires just 24 instances. Due to the two Laws of Superimposition mentioned above, these 24 instances, corresponding to the 24 positions of the ‘24 key position matrix’ can express a total of 38 Chinese sound elements and 5 tones of Chinese sounds. Thus this ‘24 key position matrix’ can give rise to many methods and devices for Chinese inputting.

Many systems can be constructed based on above principle.

We shall describe 8 of such methods/devices hereby:

Method and Device #1:

This is a method that requires a specially made keyboard. It is defined like this:

1. A keyboard that consists of at least 7 rows of keys.

2. In the first and second row there are at least 4 keys

3. In the third and fourth tow there are at least 3 keys

4. In the fifth row there are at least 4 keys

5. In the sixth row and seventh row there are at least 3 keys

6. On the key tops of those 24 keys are printed the Alphanumese symbols and Chinese tone symbols as defined in module #1.

7. For the first 14 keys, each key has two of the Alphanumese symbols, one of group A1 sound symbol and the other of Group C sound symbol

8. For the next 5 keys, each key has one Alphanumese sound symbol and another Chinese tone symbols as defined in module #1.

9. For the rest of the keys, only one Alphanumese symbol is printed

We hereby use a matrix to present such a keyboard layout:

| | 1 | 2 | 3 | 4 |
|---|---|---|---|---|
| 1 | [symbol] 8 | [symbol] O | [symbol] h | [symbol] e |
| 2 | [symbol] I | [symbol] A | [symbol] U | [symbol] W |
| 3 | [symbol] 3 | [symbol] n | [symbol] g | |
| 4 | [symbol] | [symbol] V | [symbol] 2 | |
| 5 | [symbol] — | [symbol] [symbol] | [symbol] [symbol] | [symbol] [symbol] |
| 6 | [symbol] • | [symbol] | [symbol] | |
| 7 | [symbol] | [symbol] | [symbol] | |

Note that this keyboard layout is identical to the ‘24 key position Matrix’.

This keyboard, along with its corresponding software program, would allow users to do Chinese input very efficiently. Such a keyboard arrangement is most suitable for one hand operation. It's a much needed device in computing. Above is our preferred implementation of our method as regarding to a one-hand keyboard.

Since there is not an established one-hand keyboard layout, we intend to design a standard for such one-hand keyboard. This requires the assigning of Roman alphabets (a to z) to the keys. We therefore designed a second version of our One-Hand keyboard. It is defined like this:

Method and Device #2:

This Method and Device #2 requires a keyboard similar to what's defined in Method and Device #1.

It adds one more key on row six and row seven. So these two rows would have at least 4 keys i/o three keys.

There are, therefore, at least 26 keys in this new keyboard.

We shall define hereby these 26 keys. Other keys, if present, are not relevant to the definition of this keyboard. The standard Roman alphabets, from A to Z, would be assigned to those 26 keys starting from top left, down to lower right.

We use following matrix to present such a keyboard layout:

| | 1 | 2 | 3 | 4 |
|---|---|---|---|---|
| 1 | [symbol] 8 A | [symbol] o B | [symbol] h C | [symbol] e D |
| 2 | [symbol] I E | [symbol] A F | [symbol] u G | [symbol] W H |
| 3 | [symbol] 3 I | [symbol] n J | [symbol] g K | |
| 4 | [symbol] L | [symbol] v M | [symbol] 2 N | |
| 5 | [symbol] - O | [symbol] [symbol] P | [symbol] [symbol] Q | [symbol] [symbol] R |
| 6 | [symbol] • S | [symbol] T | [symbol] U | V |
| 7 | [symbol] W | [symbol] X | [symbol] Y | Z |

Method and device #3:

The Method and Device #3 is for a standard size keyboard that is operated by both hands of the user. It has a unique keyboard layout. The layout is defined as follows:

1. There are at least 3 rows of keys in this keyboard. We shall define hereby the key assignment in these 3 rows. Keys on other rows are not relevant to the definition of this method/device

2. The first row has at least 11 keys. We shall define those 11 keys. Other keys, if present, are not relevant to the definition of this method/device

3. The second row has at least 10 keys. We shall define those 10 keys. Other keys, if present, are not relevant to the definition of this method/device

4. The third row has at least 3 keys. These 3 keys should be situated below the 5^{th}, 6^{th}, 7^{th} key of the second row. We shall define those 3 keys. Other keys, if present, are not relevant to the definition of this method/device

5. Altogether there are 24 keys.

6. The sequence of those 24 keys is defined like this:

a. Key number 1-4 are the leftmost 4 keys on first row

b. Key number 5-8 are the leftmost 4 keys on second row

c. Key number 9-11 are the 5^{th}, 6^{th}, 7^{th} key (counting from left) of the first row

d. Key number 12-14 are the 5^{th}, 6^{th}, 7^{th} key (counting from left) of the second row

e. Key number 15-18 are the 8^{th}, 9^{th}, 10^{th}, 11^{th} key (counting from left) of the first row

f. Key number 19-21 are the 8^{th}, 9^{th}, 10^{th} key (counting from left) of the second row

g. Key number 22-24 are the 3 keys of the first row that are situated below the 5^{th}, 6^{th} and 7^{th} key of the second row

h. For the first 14 keys (key number 1-14), each key has two of the Alphanumese symbols, one of group A1 sound symbol and the other of Group C sound symbol

i. For the next 5 keys (key number 15-19), each key has one Alphanumese sound symbol and another Chinese tone symbols as defined in module #1.

j. For the rest of the keys, only one Alphanumese symbol is assigned

Here is the design of this keyboard:

| | 1 | 2 | 3 | 4 | 5 | 6 | 7 | 8 | 9 | 10 | 11 |
|---|---|---|---|---|---|---|---|---|---|---|---|
| 1 | [symbol] /8 | [symbol] /o | [symbol] /h | [symbol] /e | [symbol] /3 | [symbol] /n | [symbol] /g | [symbol] - | [symbol] [symbol] | [symbol] [symbol] | [symbol] [symbol] |
| 2 | [symbol] /I | [symbol] /A | [symbol] /U | [symbol] /W | [symbol] /ø | [symbol] /V | [symbol] /2 | [symbol] • | [symbol] | [symbol] | |
| 3 | | | | | [symbol] | [symbol] | [symbol] | | | | |

Note this layout for the standard size keyboard is directly derived from the 24 position Matrix. It has gone through a very simple transformation process as defined below.

Firstly, the first 2 row of the 24 position matrix is taken and put down as the first 4 keys of both row 1 and row 2. And the resulting keys are like this:

| | | | |
|---|---|---|---|
| [symbol] /8 | [symbol] /O | [symbol] /h | [symbol] /e |
| [symbol] /I | [symbol] /A | [symbol] /U | [symbol] /W |

Then another 2 rows (row 3 and row 4) are taken from the 24 position matrix and are laid down to the right of the above keyboard layout. The resulting keys are like this:

| | | | | | | |
|---|---|---|---|---|---|---|
| [symbol] /8 | [symbol] /o | [symbol] /h | [symbol] /e | [symbol] /3 | [symbol] /n | [symbol] /g |
| [symbol] /I | [symbol] /A | [symbol] /U | [symbol] /W | [symbol] /ø | [symbol] /V | [symbol] /2 |

Then another 2 rows (row 5 and row 6) are taken from the 24 position matrix and are laid down to the right of the above keyboard layout. The resulting keys are like this:

| | | | | | | | | | | |
|---|---|---|---|---|---|---|---|---|---|---|
| [symbol] /8 | [symbol] /o | [symbol] /h | [symbol] /e | [symbol] /3 | [symbol] /n | [symbol] /g | [symbol] - | [symbol] [symbol] | [symbol] [symbol] | [symbol] [symbol] |
| [symbol] /I | [symbol] /A | [symbol] /U | [symbol] /W | [symbol] /ø | [symbol] /V | [symbol] /2 | [symbol] • | [symbol] | [symbol] | |

Finally the last row of the 24 position matrix is laid down on the third row and is placed right below the 5^{th} key of row 2. The resulting keys are now like this:

| | | | | | | | | | | |
|---|---|---|---|---|---|---|---|---|---|---|
| [symbol] /8 | [symbol] /o | [symbol] /h | [symbol] /e | [symbol] /3 | [symbol] /n | [symbol] /g | [symbol] - | [symbol] [symbol] | [symbol] [symbol] | [symbol] [symbol] |
| [symbol] /I | [symbol] /A | [symbol] /U | [symbol] /W | [symbol] /ø | [symbol] /V | [symbol] /2 | [symbol] • | [symbol] | [symbol] | |
| | | | | [symbol] | [symbol] | [symbol] | | | | |

This is how this layout is designed based on the 24 position matrix.

We have also designed an additional variation of this layout. It defines the standard Roman alphabets with basically identical key sequences. Certainly due to the fact that there are 26 Roman alphabets, there would be slight difference of key sequence as compared to the above layout.

Method and Device #4:

This Method and Device #4 is a keyboard device as defined below:

1. All the keys as defined in ‘Method and Device #3’ is required

2. One more key is added to the right of the 21^{st} key of that layout. This new key becomes the 22^{nd} key of this layout

3. One more key is added to the right of the 24^{th} key of that layout. And the 3^{rd} row would now have 4 keys. Those 4 keys are now the 23^{rd}, 24^{th}, 25^{th} and 26^{th} key of this layout.

4. 26 Roman alphabets are assigned to the above defined 26 keys in its natural sequence (A to Z).

| | 1 | 2 | 3 | 4 | 5 | 6 | 7 | 8 | 9 | 10 | 11 |
|---|---|---|---|---|---|---|---|---|---|---|---|
| 1 | [symbol] /8 | [symbol] /o | [symbol] /h | [symbol] /e | [symbol] /3 | [symbol] /n | [symbol] /g | [symbol] | [symbol] [symbol] | [symbol] [symbol] | [symbol] |
| | (A) | (B) | (C) | (D) | (I) | (J) | (K) | (O) | (P) | (Q) | (R) |
| 2 | [symbol] /I | [symbol] /A | [symbol] /U | [symbol] /W | [symbol] /ø | [symbol] /V | [symbol] /2 | [symbol] • | [symbol] | [symbol] | |
| | (E) | (F) | (G) | (H) | (L) | (M) | (N) | (S) | (T) | (U) | (V) |
| 3 | | | | | [symbol] | [symbol] | [symbol] | | | | |
| | | | | | (W) | (X) | (Y) | (Z) | | | |

Method and Device #5:

This ‘Method and Device 5’ requires a standard numerical keypad or cell phone. It is a method that enables users to do Chinese inputting with ease.

There are many occasions where a very small keyboard are used, such as those used in cell phones and the numerical keypad. In those small keyboards or keypads, typically only the numbers are present, along with a few auxiliary keys.

We, therefore, consider designing a Chinese input method using only the number keys to be very important. Besides, since our invention are mainly meant to help English speaking people to learn and to use Chinese, we believe a solution for inputting English, compatible with Chinese input method, should be designed together in this invention.

This method uses the same 24 key position matrix as the main design guide line. We now show this matrix again here:

| | 1 | 2 | 3 | 4 |
|---|---|---|---|---|
| 1 | [symbol] 8 | [symbol] O | [symbol] h | [symbol] e |
| 2 | [symbol] I | [symbol] A | [symbol] U | [symbol] W |
| 3 | [symbol] 3 | [symbol] n | [symbol] g | |
| 4 | [symbol] | [symbol] V | [symbol] 2 | |
| 5 | [symbol] — | [symbol] [symbol] | [symbol] [symbol] | [symbol] [symbol] |
| 6 | [symbol] • | [symbol] | [symbol] | |
| 7 | [symbol] | [symbol] | [symbol] | |

We assign a numerical code to each of the 38 Chinese sound elements and each of the 5 Chinese tones according to the following scheme:

The numerical code is constructed by using the row number and the column number of each of those sound elements and tone elements according to its respective cell location in the matrix. So [symbol] would be 11, [symbol] would be 12 etc.

We hereby tabulate all the assignments here:

| Chinese | | Chinese | | Chinese | | Chinese | |
|---|---|---|---|---|---|---|---|
| sound | | sound | | sound | | sound | |
| element | Its | element | Its | element | Its | element | Its |
| or | assigned | or | assigned | or | assigned | or | assigned |
| Chinese | numerical | Chinese | numerical | Chinese | numerical | Chinese | numerical |
| tones | code | tones | code | tones | code | tones | code |
| [symbol] | 11 | [symbol] | 51 | 8 | 11 | [symbol] | 51 |
| [symbol] | 12 | [symbol] | 52 | h | 12 | [symbol] | 52 |
| [symbol] | 13 | [symbol] | 53 | h | 13 | [symbol] | 53 |
| [symbol] | 14 | [symbol] | 54 | g | 14 | [symbol] | 54 |
| [symbol] | 21 | [symbol] | 61 | I | 21 | • | 61 |
| [symbol] | 22 | [symbol] | 62 | A | 22 | | |
| [symbol] | 23 | [symbol] | 63 | U | 23 | | |
| [symbol] | 24 | | | W | 24 | | |
| [symbol] | 31 | [symbol] | 71 | 3 | 31 | | |
| [symbol] | 32 | [symbol] | 72 | g | 32 | | |
| [symbol] | 33 | [symbol] | 73 | ø | 33 | | |
| [symbol] | 41 | | | V | 41 | | |
| [symbol] | 42 | | | 2 | 42 | | |
| [symbol] | 43 | | | | 43 | | |

With each Chinese sound element and each Chinese tone assigned with a numerical number, the input method can then be easily implemented.

Note above plan allows Chinese inputting to be easily accomplished with a cell phone keypad or the numerical keypads.

Method and Device #6:

We also designed a compatible input plan for the 26 Roman alphabets, in addition to the inputting method of Chinese as defined in Method and Device #5. And it is also using numerical keypad or cell phone as input device:

| | 1 | 2 | 3 | 4 |
|---|---|---|---|---|
| 1 | [symbol] 8 A | [symbol] O B | [symbol] h C | [symbol] e D |
| 2 | [symbol] I E | [symbol] A F | [symbol] U G | [symbol] W H |
| 3 | [symbol] 3 I | [symbol] n J | [symbol] g K | |
| 4 | [symbol] L | [symbol] V M | [symbol] 2 N | |
| 5 | [symbol] - O | [symbol] [symbol] P | [symbol] [symbol] Q | [symbol] [symbol] R |
| 6 | [symbol] • S | [symbol] T | [symbol] U | V |
| 7 | [symbol] W | [symbol] X | [symbol] Y | Z |

According to this keyboard layout plan, we define the numerical code for Roman alphabet A to Z according to this plan:

| | Its |
|---|---|
| | assigned |
| Roman | numerical |
| alphabet | code |
| A | 11 |
| B | 12 |
| C | 13 |
| D | 14 |
| E | 21 |
| F | 22 |
| G | 23 |
| H | 24 |
| I | 31 |
| J | 32 |
| K | 33 |
| L | 41 |
| M | 42 |
| N | 43 |
| O | 51 |
| P | 52 |
| Q | 53 |
| R | 54 |
| S | 61 |
| T | 62 |
| U | 63 |
| V | 64 |
| W | 71 |
| X | 72 |
| Y | 73 |
| Z | 74 |

We can see majority of the Roman alphabets are of the same numerical code as the Chinese sound elements or tone elements.

Would it create confusion? The answer is no. It is very easy to assign a switching key to switch between English mode and Chinese mode.

We did not use the leading 8 and 9 and 0 in this plan. So either of those keys, or even the other auxiliary keys, such as the * or # or + or − keys can all be used as the switching key.

Users can, thus, easily use numerical keypad or cell phone keypad to enter both English and Chinese at the same time.

Method and Device #7:

This method for Chinese input is using the expanded definition of Chinese input—which includes a way of expressing one's intended Chinese sound through a method. Normally such expressions are directed at computer keyboard and meant to be decoded by computer software. But in this expanded definition, the method of input could mean an alternative Chinese sound language expression.

And this Method and Device #7 is a method to express Chinese sounds through a Morse-Code like sequence of actions, such as the knocking on a pipe so that people on the other end of the pipe could interpret the pipe sounds and decodes the sounds to Chinese.

Now I describe this special way of Chinese input. Note since we have previously defined ‘Method and device #5’ which defined each Chinese sound elements with a 2 digit number.

We can use the same correlation between Chinese sound elements and two-digit numbers for a way of communication just like Morse code.

Let's now assume someone who is trapped underground. The only medium of contact between this person and the outside world is a piece of pipe.

Our Method and Device #7 can then be used to allow that person to send out Chinese phonetic scripts with the number sequence.

Example: He/she can knock the pipe 2 times, followed by 2 times to express a Chinese Morse code of 22, which is [symbol] And similarly a 3 knock followed by 3 knocks would represent Chinese Morse Code of 33, which is

[symbol]

So by using this method the trapped person can actually send out Chinese phonetic scripts to the outside world.

Method and Device #8:

As discussed above, we simply need to design a method that can allow user to express 24 double-digit numbers to another person. This double-digit number expression will be enough to transmit the Chinese sound, just like Method and Device #7.

This Method and Device #8 is simply defining a serious of finger signs to represent number 1 to 7. Any person can then simultaneous use both hands to show some of the finger signs thus defined to allow Chinese phonetic scripts to be transmitted. And people can look at the finger signs and decode them to become Chinese sounds.

One skilled in the art will understand that the embodiment of the present invention as shown in the drawings and described above is exemplary only and not intended to be limiting.

It will thus be seen that the objects of the present invention have been fully and effectively accomplished. Its embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A Chinese pronunciation key system, comprising:
a symbol set consisting of a plurality of alphabetical symbols from A to Z, and a plurality of numerical symbols from 0 to 9 representing 38 Chinese sound elements, and a plurality of alphanumerical keys, wherein each of said alphanumerical keys is shown with custom designed font to represent one of said Chinese sound elements, wherein each of said alphanumerical keys is one-symbol-one-sound-element that each of said alphanumerical keys uses one single symbol from said symbol set to represent said corresponding Chinese sound element, so as to act as pronunciation keys for Chinese words.

2. The Chinese pronunciation key system, as recited in claim 1, wherein three of said alphabetical symbols, which are G, N, and H, are used twice to represent said different Chinese sound elements as the laws of Chinese pronunciation allow such dual use of alphabetical symbols representing two different sound elements, one as a consonant, and another as a vowel.

3. The Chinese pronunciation key system, as recited in claim 1, wherein said 38 Chinese sound elements are corresponding to Bopomofo symbols consisting of [symbol] [symbol] [symbol] [symbol] [symbol] [symbol] [symbol] being represented by symbols of [symbol] [symbol] [symbol] [symbol] [symbol] [symbol] respectively, which are formed by using custom-designed fonts on namesake keys B P M F D T N L G K H 9 7 X J Q D R Z C 4 1 5 Y 8 0 H E I A U W T 3 N G 0 V 2 respectively.

4. The Chinese pronunciation key system, as recited in claim 2, wherein said 38 Chinese sound elements are corresponding to Bopomofo symbols consisting of [symbol] [symbol] [symbol] [symbol] [symbol] [symbol] [symbol] being represented by symbols of [symbol] [symbol] [symbol] [symbol] [symbol] [symbol] respectively, which are formed by using custom-designed fonts on namesake keys B P M F D T N L G K H 9 7 X J Q D R Z C 4 1 5 Y 8 O H E I A U W 3 N G 0 V 2 respectively.

5. The Chinese pronunciation key system, as recited in claim 3, further comprising a plurality of tonal symbols applying onto 24 vowels of said 38 Chinese sound elements, wherein each of said alphanumerical keys correspondingly representing one of said 24 vowels of said Chinese sound elements takes 5 forms which are tone 1, tone 2, tone 3, tone 4, and light sound by using different fonts onto the same alphanumerical keys.

6. The Chinese pronunciation key system, as recited in claim 4, further comprising a plurality of tonal symbols applying onto 24 vowels of said 38 Chinese sound elements, wherein each of said alphanumerical keys correspondingly representing one of said 24 vowels of said Chinese sound elements takes 5 forms which are tone 1, tone 2, tone 3, tone 4, and light sound by using different fonts onto the same alphanumerical keys.

7. A Chinese Romanization system, comprising a plurality of alphabet symbols for representing 38 Chinese sound elements respectively, wherein each of said alphabet symbols consists of one or more of Roman alphabets from A to Z being used for representing said respective Chinese sound element for transcribing Chinese characters into Romanized scripts that is highly compatible with English phonics.

8. The Chinese Romanization system, as recited in claim 7, wherein said 38 Chinese sound elements are corresponding to Bopomofo symbols consisting of [symbol] [symbol] [symbol] [symbol] [symbol] [symbol] [symbol] being represented by symbols of B P M F D T N L G K J Ch Shi Dr Tr Sr Rr Dz Tz Sz i u yu a o uh e ii ay ou ow an un ang ung ong er respectively.

9. The Chinese Romanization system, as recited in claim 7, further comprising a plurality of tonal symbols applying onto 24 vowels of said 38 Chinese sound elements, wherein each of said alphabet symbols correspondingly representing one of said 24 vowels of said Chinese sound elements takes 5 forms which are tone 1, tone 2, tone 3, tone 4, and light sound by using different fonts on the last alphabet of the said alphabet symbols.

10. The Chinese Romanization system, as recited in claim 8, further comprising a plurality of tonal symbols applying onto 24 vowels of said 38 Chinese sound elements, wherein each of said alphabet symbols correspondingly representing one of said 24 vowels of said Chinese sound elements takes 5 forms which are tone 1, tone 2, tone 3, tone 4, and light sound by using different fonts on the last alphabet of the said alphabet symbols.

11. A method for inputting Chinese pronunciation key symbols, Chinese Romanized scripts and Chinese characters, comprising the steps of:
(a) entering one or more of 38 Chinese sound elements through 35 alphanumerical keys which represent 38 Chinese sound elements, wherein each of said alphanumerical keys is selected from one of alphabetical symbols from A to Z and numerical symbols from 0 to 9;
(b) entering one of 5 activating keys that represent 5 tones and thus complete the specifying of the sound intended; and
(c) outputting one of a pronunciation key symbol, a Romanized Chinese script, and a Chinese character in responsive to said alphanumerical keys and said activating key.

12. The method, as recited in claim 11, wherein said alphanumerical keys and said activating keys are entered through a keyboard.

13. The method, as recited in claim 12, wherein said keyboard contains 35 keys assigned for said alphanumerical keys respectively and 5 said activating keys assigned for tonal symbols respectively.

14. The method, as recited in claim 13, wherein said 5 activating keys are semi-colon key, left bracket key, right bracket key, left shift key, and right shift key respectively.

15. The method, as recited in claim 11, wherein three of said alphabetical symbols, which are G, N, and H, are used twice to represent said different Chinese sound elements as the laws of Chinese pronunciation allow such dual use of alphabetical symbols representing two different sound elements, one as a consonant, and another as a vowel.

16. The method, as recited in claim 14, wherein three of said alphabetical symbols, which are G, N, and H, are used twice to represent said different Chinese sound elements as the laws of Chinese pronunciation allow such dual use of alphabetical symbols representing two different sound elements, one as a consonant, and another as a vowel.

17. The method, as recited in claim 11, wherein said 38 Chinese sound elements are corresponding to Bopomofo symbols consisting of [symbol] [symbol] [symbol] [symbol] [symbol] [symbol] [symbol] being represented by symbols of [symbol] [symbol] [symbol] [symbol] [symbol] [symbol] [symbol] respectively, which are formed by using custom-designed fonts on namesake keys respectively.

18. The method, as recited in claim 16, wherein said 38 Chinese sound elements are corresponding to Bopomofo symbols consisting of [symbol] [symbol] [symbol] [symbol] [symbol] [symbol] [symbol] being represented by symbols of B [symbol] [symbol] [symbol] [symbol] [symbol] [symbol] [symbol] respectively, which are formed by using custom-designed fonts on namesake keys B P M F D T N L G K H 9 7 X J Q D R Z C 4 1 5 Y8 O H E I A U W 3 N G 0 V 2 respectively.

19. A method of inputting one of Chinese pronunciation key symbols, Chinese Romanized scripts, and Chinese characters, comprising the steps of:
(a) assigning 24 keys of a keyboard for “24 key position Chinese sound Matrix”, wherein said “24 key position Chinese sound Matrix” is:

| | 1 | 2 | 3 | 4 |
|---|---|---|---|---|
| 1 | [symbol] 8 | [symbol] O | [symbol] h | [symbol] e |
| 2 | [symbol] I | [symbol] A | [symbol] U | [symbol] W |
| 3 | [symbol] 3 | [symbol] n | [symbol] g | |
| 4 | [symbol] | [symbol] V | [symbol] 2 | |
| 5 | [symbol] - | [symbol] [symbol] | [symbol] [symbol] | [symbol] [symbol] |
| 6 | [symbol] • | [symbol] | [symbol] | |
| 7 | [symbol] | [symbol] | [symbol] | |

(b) entering one or more said keys in order to express intended Chinese sound elements and tone that constitute the pronunciation of a Chinese word; and
(c) outputting one of said Chinese pronunciation key symbol, said Chinese Romanized script, said corresponding Chinese character in responsive to said keys.

20. The method, as recited in claim 19, wherein said intended Chinese sound elements are among 38 Chinese sound elements corresponding to Bopomofo symbols consisting of [symbol] [symbol] [symbol] [symbol] [symbol] [symbol] [symbol] being represented by symbols of [symbol] [symbol] [symbol] [symbol] [symbol] [symbol] [symbol] respectively, which are formed by using custom-designed fonts on namesake keys B P M F D T N L G K H 9 7 X J Q D R Z C 4 1 5 Y 8 O H E I A U W 3 N G 0 V 2 respectively.

21. The method, as recited in claim 20, wherein said Chinese tone is among 5 Chinese tones known as tone 1, tone 2, tone 3, tone 4 and light sound.

22. A keyboard device for inputting one of Chinese pronunciation key symbols, Chinese Romanized scripts, and Chinese characters, comprising a keyboard having 24 keys assigned for “24 key position Chinese sound Matrix”, wherein said “24 key position Chinese sound Matrix” is:

| | 1 | 2 | 3 | 4 |
|---|---|---|---|---|
| 1 | [symbol] 8 | [symbol] O | [symbol] h | [symbol] e |
| 2 | [symbol] I | [symbol] A | [symbol] U | [symbol] W |
| 3 | [symbol] 3 | [symbol] n | [symbol] g | |
| 4 | [symbol] | [symbol] V | [symbol] 2 | |
| 5 | [symbol] - | [symbol] [symbol] | [symbol] [symbol] | [symbol] [symbol] |
| 6 | [symbol] • | [symbol] | [symbol] | |
| 7 | [symbol] | [symbol] | [symbol] | |

wherein when one or more said keys are entered in order to express the intended Chinese sound element and tone that constitute the pronunciation of a Chinese words, one of said Chinese pronunciation key symbol, said Chinese Romanized script, and said corresponding Chinese character in responsive to said keys is outputted.

23. The keyboard device, as recited in claim 22, wherein said intended Chinese sound elements are among 38 Chinese sound elements corresponding to Bopomofo symbols consisting of [symbol] [symbol] [symbol] [symbol] [symbol] [symbol] being represented by symbols of [symbol] [symbol] [symbol] [symbol] [symbol] [symbol] respectively, which are formed by using custom-designed fonts on namesake keys B P M F D T N L G K H 9 7 X J Q D R Z C 4 1 5 Y 8 O H E I A U W 3 N G 0 V 2 respectively.

24. The keyboard device, as recited in claim 23, wherein a keyboard layout of said 24 keys are of 7 rows and 4 columns exactly arranged as per said “24 key position Chinese sound Matrix”.

25. The keyboard device, as recited in claim 24, wherein 1 additional key on the 6^{th} row and 1 additional key on the 7^{th} row are added to said keyboard to allow a total of 26 keys to represent 26 Roman alphabets as shown in this following scheme:

| | 1 | 2 | 3 | 4 |
|---|---|---|---|---|
| 1 | [symbol] 8 A | [symbol] O B | [symbol] h C | [symbol] e D |
| 2 | [symbol] I E | [symbol] A F | [symbol] U G | [symbol] W H |
| 3 | [symbol] 3 I | [symbol] n J | [symbol] g K | |
| 4 | [symbol] L | [symbol] V M | [symbol] 2 N | |
| 5 | [symbol] - O | [symbol] [symbol] P | [symbol] [symbol] Q | [symbol] [symbol] R |
| 6 | [symbol] • S | [symbol] T | [symbol] U | V |
| 7 | [symbol] W | [symbol] X | [symbol] Y | Z |

26. The keyboard device, as recited in claim 23, wherein a keyboard layout of said 24 keys are of 3 rows with first row of 11 keys, the second row of 10 keys and the third row of at 3 keys arranged as per a mentally reconstructed “24 key position Chinese sound Matrix” according to following scheme:
(a) keyboard row 1 key 1-4 counting from left correspond to matrix row 1;
(b) keyboard row 2 key 1-4 counting from left correspond to matrix row 2;
(c) keyboard row 1 key 5-7 counting from left correspond to matrix row 3;
(d) keyboard row 2 key 5-7 counting from left correspond to matrix row 4;
(e) keyboard row 1 key 8-11 counting from left correspond to matrix row 5;
(f) keyboard row 2 key 8-10 counting from left correspond to matrix row 6;
(g) keyboard row 3 key 1-3 (below key 5-7 of row 2) correspond to matrix row 7;
wherein a completed keyboard design with a mentally reconstructed 24 key position matrix is shown as:

| | 1 | 2 | 3 | 4 | 5 | 6 | 7 | 8 | 9 | 10 | 11 |
|---|---|---|---|---|---|---|---|---|---|---|---|
| 1 | [symbol] /8 | [symbol] /o | [symbol] /h | [symbol] /e | [symbol] /3 | [symbol] /n | [symbol] /g | [symbol] - | [symbol] [symbol] | [symbol] [symbol] | [symbol] [symbol] |
| 2 | [symbol] /I | [symbol] /A | [symbol] /U | [symbol] /W | [symbol] /ø | [symbol] /V | [symbol] /2 | [symbol] • | [symbol] | [symbol] | |
| 3 | | | | | [symbol] | [symbol] | [symbol] | | | | |

27. The keyboard device, as recited in claim 26, wherein 1 additional key on the second row and 1 additional key on the third row are added to the keyboard to allow a total of 26 keys to represent the 26 Roman alphabets as shown in this following scheme:

| | 1 | 2 | 3 | 4 | 5 | 6 | 7 | 8 | 9 | 10 | 11 |
|---|---|---|---|---|---|---|---|---|---|---|---|
| 1 | [symbol] /8 | [symbol] /o | [symbol] /h | [symbol] /e | [symbol] /3 | [symbol] /n | [symbol] /g | [symbol] - | [symbol] [symbol] | [symbol] [symbol] | [symbol] |
| | (A) | (B) | (C) | (D) | (I) | (J) | (K) | (O) | (P) | (Q) | (R) |
| 2 | [symbol] /I | [symbol] /A | [symbol] /U | [symbol] /W | [symbol] /ø | [symbol] /V | [symbol] /2 | [symbol] • | [symbol] | [symbol] | |
| | (E) | (F) | (G) | (H) | (L) | (M) | (N) | (S) | (T) | (U) | (V) |
| 3 | | | | | [symbol] | [symbol] | [symbol] | | | | |
| | | | | | (W) | (X) | (Y) | (Z) | | | |

28. A method of expressing one's intended Chinese pronunciation key script of an intended Chinese character by the simulation of using a virtual 24 key position Chinese sound Matrix, comprising the steps of:
(a) assigning 24 virtual keys of a virtual keyboard for “24 key position Chinese sound Matrix as expressed in standard matrix cell location format”, wherein said “24 key position Chinese sound Matrix as expressed in standard matrix cell location format” is:

| | |
|---|---|
| [symbol] 8 | 11 |
| [symbol] O | 12 |
| [symbol] h | 13 |
| [symbol] e | 14 |
| [symbol] I | 21 |
| [symbol] A | 22 |
| [symbol] U | 23 |
| [symbol] W | 24 |
| [symbol] 3 | 31 |
| [symbol] n | 32 |
| [symbol] g | 33 |
| [symbol] ø | 41 |
| [symbol] V | 42 |
| [symbol] 2 | 43 |
| [symbol] [symbol] | 51 |
| [symbol] [symbol] | 52 |
| [symbol] [symbol] | 53 |
| [symbol] [symbol] | 54 |
| [symbol] • | 61 |
| [symbol] | 62 |
| [symbol] | 63 |
| [symbol] | 71 |
| [symbol] | 72 |
| [symbol] | 73 |

(b) assigning a plurality of actions that are as per the definition of the virtual keys in order to express the intended Chinese sound elements and tone that constitute the pronunciation of a Chinese word; and
(c) completing the expressing of intended pronunciation script of said intended Chinese character ready to be interpreted.

29. The method, as recited in claim 28, wherein said intended Chinese sound elements are among the 38 Chinese sound elements corresponding to Bopomofo symbols consisting of [symbol] [symbol] [symbol] [symbol] [symbol] [symbol] [symbol] being represented by symbols of [symbol] [symbol] [symbol] [symbol] [symbol] [symbol] respectively, which are formed by using custom-designed fonts on namesake keys B P M F D T N L G K H 9 7 X J Q D R Z C 4 1 5 Y 8 O H E I A U W 3 N G 0 V 2 respectively.

30. The method, as recited in claim 29, wherein said Chinese tone is among the 5 Chinese tones known as tone 1, tone 2, tone 3, tone 4 and light sound.

31. The method, as recited in claim 28, wherein said virtual keyboard is a numerical keypad or the keypad on a handheld device that only has numerical keys and no alphabetical key; which uses two key pressing of said virtual keyboard to represent one key stroke that conforms to the “24 key position Chinese sound matrix as expressed in standard matrix cell location format”.

32. The method, as recited in claim 28, wherein said virtual keyboard is an imaginary keyboard operated by an audible or perceivable action, wherein said action is selected from the group consisting of successively knocking on a pipe, successively flipping of a mirror, and pre-defining hand signs, finger signs and touch-screen signs, wherein said actions are used as the means to convey two digit numbers as shown on said “24 key position Chinese sound matrix as expressed in standard matrix cell location format”.
